(19) United States
(12) Patent Application Publication
(10) Pub. No.: US 2004/0158865 A1
(43) Pub. Date: Aug. 12, 2004

(54) System and method for managing in-theater display advertisements

(76) Inventors: Kenneth M. Kubler, Flower Mound, TX (US); John C. Poortinga, Ramona, CA (US); Joseph J. Hasson, Encino, CA (US); Jeff Johnson, Garland, TX (US); Don Merritt, Garland, TX (US); Tom Hintz, Perris, CA (US)

Correspondence Address: CHRISTIE, PARKER & HALE, LLP, P.O. BOX 7068, PASADENA, CA, 91109-7068, US

(21) Appl. No.: 10/719,608

(22) Filed: Nov. 21, 2003

Related U.S. Application Data
(63) Continuation-in-part of application No. PCT/US02/16484, filed on May 24, 2002.
(60) Provisional application No. 60/293,699, filed on May 24, 2001.
(60) Provisional application No. 60/316,174, filed on Aug. 30, 2001.
(60) Provisional application No. 60/356,827, filed on Feb. 14, 2002.

(51) Int. Cl. H04N 7/18; G06F 13/00; H04N 7/173; H04N 7/025

(52) U.S. Cl. 725/82; 725/32; 725/36; 725/42; 725/113; 725/109; 725/110; 725/112; 725/74

(57) ABSTRACT

A library of video advertisements are stored at a clearing house for distribution to a plurality of geographically separated theaters along with display schedules of the transmitted video advertisements. A network such as the Internet connects the clearing house to the theaters. At the theaters, the transmitted video advertisements are displayed according to the schedules. A log of the displayed advertisements is compiled at each theater and transmitted by the network to the clearing house. In addition, one or more parameters representative of attendance and/or demographics at the theater are also transmitted by the network to the clearing house.

### CROSS-REFERENCE TO RELATED APPLICATIONS

This application is a continuation-in-part of PCT Patent Application No. PCT/US02/16484 filed May 24, 2002, which claimed the benefit of Provisional Application Nos. 60/293,699 filed May 24, 2001, 60/316,174 filed Aug. 30, 2001 and 60/356,827 filed Feb. 14, 2002, the disclosures of which are incorporated fully herein by reference.

### BACKGROUND OF THE INVENTION

This invention relates to in-theater display advertisements and, more particularly, to electronic distribution of video display advertisements to geographically separated theaters.

Video display advertisements are displayed at motion picture theaters prior to the feature film. This activity is a substantial source of revenue for the theater owners. Currently, the advertisements are distributed to the theaters as 35 mm slides carried in carousels. It is costly and inconvenient to deliver the advertisements to the theaters and the order of the display cannot be easily changed.

### SUMMARY OF THE INVENTION

A library of video advertisements are stored in electronic form at a clearing house for distribution to a plurality of geographically separated theaters along with display schedules of the transmitted video advertisements. A network such as the Internet connects the clearing house to the theaters. At the theaters, the transmitted video advertisements are displayed according to the schedules, which can be changed according to the circumstances. A log of the displayed advertisements is compiled at each theater and transmitted by the network to the clearing house. In addition, one or more parameters representative of attendance and/or demographics at the theaters are also transmitted by the network to the clearing house to audit the effectiveness of the advertisements being displayed.

### BRIEF DESCRIPTION OF THE DRAWINGS

The features of specific embodiments of the best mode contemplated of carrying out the invention are illustrated in the drawings, in which:

FIG. 1 is a schematic block diagram of a system for managing in-theater display advertisements;

FIG. 2 is a schematic block diagram of components located at one of the theaters shown in FIG. 1;

FIG. 3 is a schematic block diagram of components connected to the clearing house shown in FIG. 1;

FIG. 4 is a schematic block diagram of a number of parameter sensors located in one of the theaters shown in FIG. 1;

FIG. 5 is a schematic block diagram of components at one of the theaters shown in FIG. 1 for modifying the advertising display schedule;

FIG. 6 is a schematic diagram of one of the theaters shown in FIG. 1, together with components for producing interactive media content on a theater movie screen;

FIG. 7 is a block diagram representing a quiz system interleaved with advertisements;

FIGS. 8-10 illustrate various component configurations of an in-theater display advertisement system according to the invention;

FIGS. 11-13 illustrate some of the functionality of the system of FIG. 1;

FIG. 14 illustrates use of the Internet to interconnect the described system components;

FIG. 15 depicts an embodiment of an injector-projector for inserting advertisements into the image projection path of a theater;

FIGS. 16A-C depict one location for the injector in a projection lens system;

FIG. 17 depicts a remote wireless transmitter for receiving interactive patron inputs;

FIG. 18 illustrates an image display created by an in-theater controller and quiz system in accordance with the invention;

FIG. 19 illustrates a number of frames of an advertising display created by an injector-projector described in FIGS. 15-18;

FIG. 20 depicts the contents of a number of data blocks used in the in-theater display advertisement system;

FIG. 21 is a schematic block diagram of the advertising quiz and survey process;

FIG. 22 is a schematic block diagram of a routine for communicating between system components;

FIG. 23 is a schematic block diagram of a process for receiving interactive patron inputs through the remote wireless transmitter of FIG. 17;

FIGS. 24 and 25 are schematic block diagrams of configurations that perform in-theater management functions according to the invention; and

FIG. 26 illustrates security measures used in an in-theater setting to control access to the components.

### DETAILED DESCRIPTION OF THE INVENTION

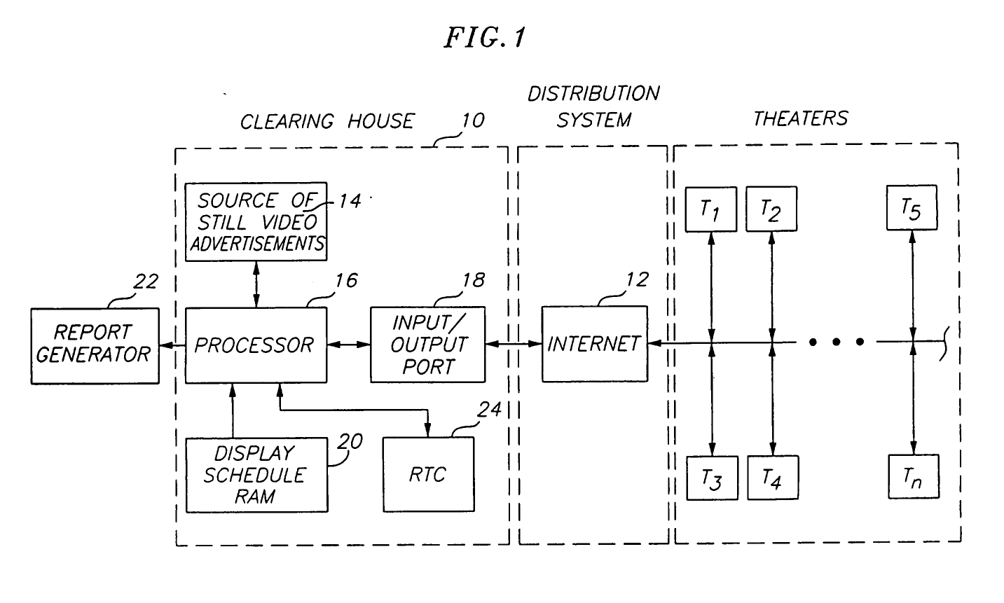

In FIG. 1 a clearing house 10 is coupled by a distribution system, preferably the Internet 12, to a plurality of remotely distributed retail establishments, namely a plurality of motion picture theaters T₁ to T_{n . . .} . At clearing house 10, an advertising source 14 stores still or movie clip video advertisements, preferably in electronic form. Typically, source 14 comprises a mass storage medium. An electronic clearing house processor 16 controls the operations at clearing house 10. Clearing house 10 gains access to Internet 12 through an input/output port 18. Port 18 has a bidirectional interface with Internet 12 and receives advertisements from source 14. Port 18 serves to convert the data it receives or transmits to and from an appropriate protocol for transmission on the distribution system, e.g., IP/TCP in the case of the Internet. Processor 16 has a bidirectional connection to source 14 by which processor 16 controls selections of advertisements stored in source 14 and receives confirmation that the selected advertisements have been sent to port 18 for distribution over Internet 12. A RAM 20, which is connected to processor 16, stores an advertisement display schedule for theaters T₁ to T_{n . . .} . A real time clock (RTC) 24, which is also connected to processor 16, provides a time base for operation of the system. Local clocks (not shown) at theaters T₁ to T_{n . . .} are synchronized to RTC 24. Processor 16 is coupled to a report generator 22. Messages from theaters T₁ to T_{n . . .} are also sent upstream over Internet 12 to clearing house 10. These messages, which may include a log of the advertisements actually displayed at each theater, are relayed by port 18 to processor 16. RAM 12 is coupled to processor 16. The schedule stored in RAM 20 includes times, theaters, and advertisement identification. A report generator 22 is controlled by processor 16.

In operation, schedule 20 includes for each theater individually the times, theater id's, and advertisement id's. This data is sent to processor 16 so processor 16 can select the advertisements at the appropriate times (either real time or delayed time) and send them via port 18 to Internet 12 for distribution to theaters T₁ to T_{n . . .} . The advertisements are selected by means of the advertisement id's, which are appended to the distributed advertisements transmitted to theaters T₁ to T_{n . . .} Processor 16 appends the theater id's to the advertisements at port 18 before transmission so each scheduled advertisement is routed to the scheduled theater either in real time or delayed time for display at the scheduled time. As a result, the advertisements and their time of display can be scheduled at each theater independent of the other theaters. Processor 16 also generates time stamp messages for control of the local clocks at theaters T₁ to T_{n . . .} . These time stamp messages are interleaved with the other data transmitted to theaters T₁ to T_{n . . .} over Internet 12.

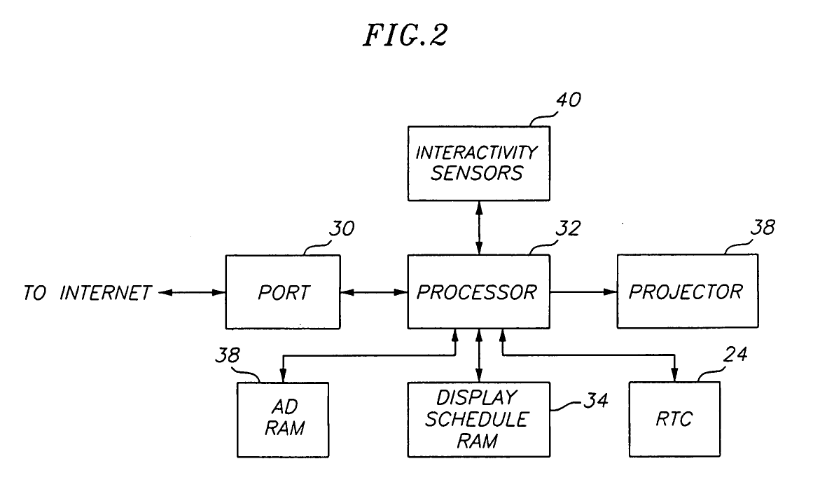

FIG. 2 illustrates components of the invention at one of the theaters. The theater gains access to Internet 12 through an input/output port 30. Port 30 has a bidirectional interface with Internet 12 and receives advertisements from source 14. Port 30 also serves to convert the data it receives or transmits to and from an appropriate protocol for transmission on the distribution system, e.g., IP/TCP in the case of the Internet. Port 30 is connected to a processor 32. A RAM 34, which stores display schedule data received from clearing house 10, has a bidirectional connection to processor 32. Another RAM 38, which stores video advertisements received from clearing house 10 in electronic form, also has a bidirectional connection to processor 32. Processor 32 forwards time stamp messages to a local real time clock 36, which is synchronized to RTC 24 (FIG. 1). Processor 32 retrieves video advertisements in electronic form from RAM 38 in accordance to the display schedule under the control of local RTC 24 and feeds them to a digital projector or image injector for interleaving with the feature motion picture program being displayed. One or more different types of interactivity sensors 40 are fed to processor 32. Exemplary interactive sensors are individual seat sensors 82 that detect when a theater seat is occupied. The outputs of such sensors are coupled by wireless or hardwire to processor 32. A number of other types of interactivity that can be practiced with the invention are described below.

A log of the displayed advertisements (advertisement id, theater id, and time) is recorded at each theater and stored in display schedule RAM 34. Periodically, this log is retrieved from RAM 34 by processor 32 and transmitted upstream via Internet 12 to clearing house 10, where it is coupled by port 18 to processor 16. Processor 16 compares the logs to the data from schedule 20 and sends the discrepancies to report generator 22. Assuming the Internet is used to distribute the advertisements to the individual theaters, each theater has its own Internet address (URL) and the data, including theater id's, display schedules, advertisements, time stamps, etc., is transmitted over the Internet according to IP/CTP. If desired each theater Tₙ in FIG. 1 could comprise a complex of separate theaters in one facility. In this case, there would be a router at each theater to direct the data to the assigned separate theaters according to the theater id.

The invention can be used to perform many functions in a theater. The following are representative of these functions.

Advertising Scheduling

Pre-Buying

The advertising agents can view all the scheduled slots and pre book advertising space as is currently industry practice. The system provides the advertising agent with two new alternatives, “Predicted Results” and “Dynamic Buying” booking. These alternatives are not feasible without automation of the in theater advertising system.

Predicted Results Booking

Predicted Results refers to buying a slot of advertising space that meets a set of criteria for a specific price. The host system assigns the advertisements to slots using the criteria, the in theater system shows the advertisements and collects real-time results used to measure how well the criteria was meet. Based on the degree of the match the advertiser is credited for lack of predicted results or pays the theater a bonus for exceeding the results.

Dynamic Buying Booking

Dynamic Buying refers to the buying a slot of advertising space through auction where the space is sold at the time it is shown. The advertising agent defines sets of criteria (ad business rule) to be meet and the price it is worth if such criteria can be meet. The in theater system collects data real-time which is used to determine which ad's business rules have been met and which ad brings the highest economic value to the theater. All ads are evaluated during the prior slot to determine which ad is shown. All the currently collected data including the following is used in the evaluation:

Tickets Sold; Tacit Viewing; Predicted Eye Ball Count; Minutes Before Feature; Genre Match; Actual Demographic Matches (Data collected via Dual Addressable Tags described below); Predicted Demographic Matches; Slot Type; Slot Day Code; Slot Time Code; Quiz Available; Time Before Quiz; Time After Quiz; Drawing Available.

Dynamic Matching

Dynamic matching is the process of assigning an advertisement to a time slot. To improve on the process of randomly assigning ads to slots, a business rules log is used to determine to which slot an ad should be assigned to create the most economic value for both the advertiser and the theatre operator.

Dynamic Slotting

The ads and slots are scored based on score rules, then they are matched based on the matching rules, then they are displayed. At the same time the ad is displayed the theater statistics are collected and after the completion of the display of the ad, all statistics are logged. All remaining ads and slots are re-scored during each slotting cycle. All processes are executed concurrently as to allow for efficient processing.

Slotting Cycle

Displaying the advertisement requires the least amount of system resources. While an ad is being displayed, all the necessary processing is performed to determine which ad will be displayed in the next slot.

Scoring

Both the content object and the slot object are scored based on the business rules assigned. The slot object supports the following: Slots; Slot Offer Price (The price is calculated based on its position in the loop, the actual reach and the number of ads that match the demographics of its target audience.); Slot Position; Slot Reach; Content; Content Bid Price; Content Demographics; Content; Position; and Content Reach.

Matching

The matching agent uses matching business rules to determine which ad to assign to the slot in question.

Audience Derived Data

Quiz Data Collection

Synchronized with each quiz question is an answer from each respondent. The response or answer is collected via the key pad on response devices attached to the top or back of each auditorium chair. The row and column number of the seat is also collected in addition to the date and time.

Ticket Sales Data Collection

The system is connected electronically to collect the ticket sales for each theater. The data is collected at the beginning of each slot for each screen loop.

People Count

There are three methods for counting the theater population. First, a motion detector counts the number of persons moving in and out of a theater (screen specific) entrance. The device categorizes the people as possible adult or minor and the data is fed into real-time audience demographics. The counting starts at a specific time before the preview to reduce false counts of persons leaving after the last show or cleaning the theater. This time is part of the schedule.

Second, the number of persons entering the complex is captured using the technology of the first method. In addition, one or more of the following parameters are measured:

Audience=tickets sold for screen

C-Factor=Percent of Persons in Concession Lines before Screening

R-Factor=Percent of Persons in Rest Room or Other before Screening

S-Factor=Percent of Persons who Sneak in

Concessions=Estimated number of Persons in Concession Lines

Total Audience=Number of Persons that Entered Complex

Eye Balls=Estimated Number of Persons in Theater

Live=Total Number of Tickets sold for a Screening that is Showing

LC-Factor=Percent of Persons in Concessions lines while their show is live

Complete=Number of Persons in Movies that have Ended

Pre-Live-Concessions=Concessions−(LC-Factor*Live)^{+n(each theater/screen)}

Available=Total-Audience ((complete)ⁿ⁺+(Live/(1+LC-Factor)⁺ⁿ)

Audience-Factor=Audience/Σ(Audience)⁺ⁿ

Eye-Balls=Available

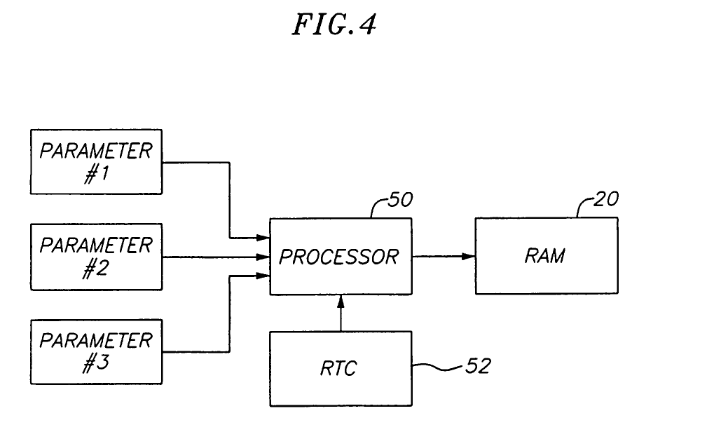

In a fashion similar to FIG. 4 coefficients are empirically determined, the coefficients are multiplied by the measured values, and the products summed to provide a people count.

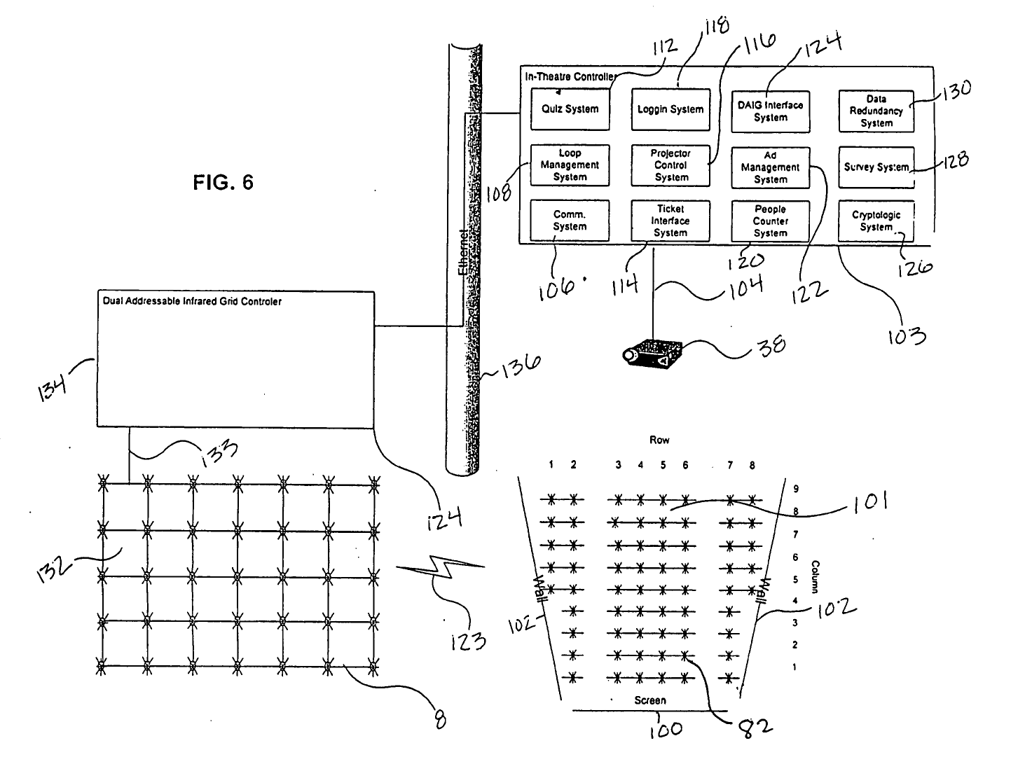

Third, a sensor is attached to each chair to sense if the seat is occupied. With reference to theater plan view shown in FIG. 6, the sensors could be represented by the asterisks 82. Each seat is coupled by the infrared grid controller 134 to processor 32 (FIG. 2) for transmission to clearing house 10.

Surveys

As represented in FIG. 6, accurate commercial data such as the demographics of the audience are collected in real-time through an electronic survey generated by a survey system 128 which is projected on the screen 100. Advertisers can also embed surveys into the advertisement to collect data specific to the advertisement's content. The survey answers are collected through electronic data collection devices 82. The devices 82 are located at the individual seats of the survey subjects in the theater. The survey data can be transmitted to clearing house 10 through the grid controller and the Internet. An electronic contest/raffle can be used to increase the audience participation in the survey.

Raffle

The degree of a viewers participation in a quiz or survey is tracked real-time by the quiz/raffle system (112). The quiz and survey systems (103) send the quiz/raffle system (112) electronic raffle tickets when the participant completes a quiz or survey. Each ticket contains the seat row and column number, the data collection devices and an electronically created raffle ticket number. The raffle service randomly draws the number of requested winning tickets. The raffle system sends a command to the device's LED, which is illuminated. The seat location of the winning holders can also be displayed on the projector.

Managing Audience Attention to the Advertisements

Quizzes

The quiz questions increases the audience attention because the advertisements are integrated into the quiz screen. The audience is also more likely to follow each advertisement in the loop because they do not know when the next quiz question will be displayed. The system can measure and report the degree of attention by dividing the number of persons participating in the quiz and the number of persons seated.

Raffles

Another technique to increase the audience's attention is to reward responses to quiz questions and surveys. An electronic raffle ticket can be issued for each desired action from the viewer.

Dual Addressable Data Collections Device

Use of the Dual Addressable Infrared Grid (DAIG) and low power consumption devices that communicate through it provide a significant economic advantage by allowing a low cost means to collect audience reach and demographics data. In addition, the data collection system can be used for activities that increase the audience's attention to the advertisements.

Instead of or in addition to video advertising images, the system could distribute audio advertisements from the clearing house to the theaters for sound reproduction in the lobby or auditorium in the same manner described above.

Dual Addressable Infrared Grid 8 (FIG. 6) is used to determine the location of each device to allow the controller and in-theater servers to accurately assign the seat column and row number. It is also used to transmit data to clearing house 10 via processor 32 and the Internet. Reference is made to U.S. Pat. Nos. 5,299,117 and 5,572,653 for further details about grid controller 134. Each theater complex contains one or more individual theaters/screens in close proximity to each other.

The device at each seat contains a LED that can be turned on or off via a command from the grid controller. The LED can be instructed to flash at a rate that is either hard coded or provided by command from the controller. The LED can be used to communicate information to either or both the audience and staff. For example a flashing LED could indicate a winner of a drawing. The device also has a keypad for entry of data by the individual audience members.

Each loop is started at the scheduled time. Each loop is comprised of segments or ad windows. At the beginning of each ad window each business rule in the LOOP BUSINESS RULE set is evaluated to dynamically determine which ad to display in the current or proceeding window. Business rules are evaluated in sequential order. Business rules are ordered based on their economic value. The economic value of the rules is calculated dynamically prior to the beginning of each ad window.

Each ad is associated with a business rule or set of business rules. The association or linking of an ad's rules can be based on only the ad or on the loop it has been associated or assigned to. For example the business rule may only come into play if the loops attributes meet the business rule criteria.

Dynamic Matching

Dynamic matching is the process of assigning an advertisement to a time slot. To improve on the process of randomly assigning ads to slots, a business rules log is used to determine which slot an ad should be assigned in order to create the most economic value for both the advertiser and the theater operator

Dynamic Slotting

The ads and slots are scored based on score rules, then they are matched based on the matching rules, then they are displayed. At the same time the ad is displayed the theater statistics are collected and after the completion of the display of the ad, all statistics are logged. All remaining ads and slots are re-scored during each slotting cycle. All processes are executed concurrently as to allow for efficient processing.

Slotting Cycle

Displaying the advertisement requires the least amount of system resources. While an ad is being displayed, all the necessary processing is performed to determine which ad will be displayed in the next slot.

Scoring

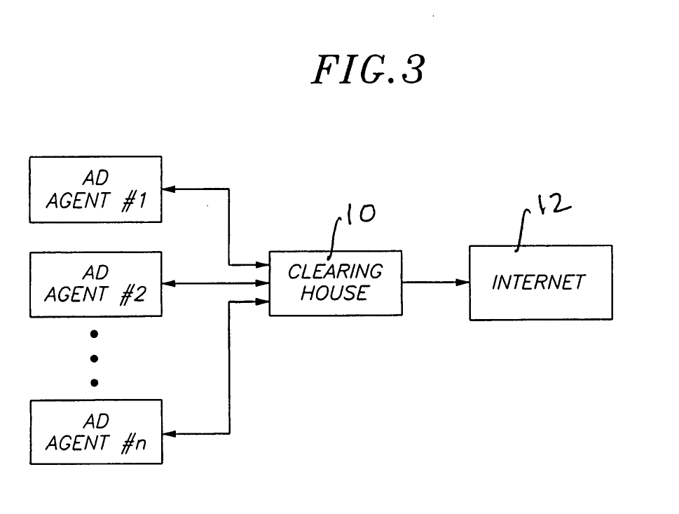

Both the content object and the slot object are scored based on the business rules assigned. The slot object supports the following: Slots; Slot Offer Price: The price is calculated based on its position in the loop, the actual reach and the number of ads that match the demographics of its target audience. In FIG. 3, a plurality of ad agent stations #1, #2, . . . , #n are connected to clearing house 10 where processor 16 is programmed to create an advertising display schedule responsive to the inputs from stations #1 to #n based on given fixed rate schedules and/or rules for creating dynamic rate schedules in real time. Advertisers give the ad agents at stations #1 to #n the information necessary to create the advertising display schedules and this information is transmitted to clearing house 10 by the Internet or fixed connection to which advertisers subscribe and other inputs including those described below. As described in FIG. 1, the resulting advertising display schedule is distributed over the Internet 12 to the individual theaters.

In FIG. 4, a number of parameter sensors #1, #2, #3, etc., measure such parameters as the number of tickets sold, the particular motion picture being shown, the number of patrons at the concession stands, the time before the feature that the video advertisement is displayed, etc., at a particular theater during the display of each video advertisement. The outputs from the sensors are used to predict the actual number of pairs of eyes viewing the displayed advertisement. This predicted number is the basis of the fee charged to the advertiser. To this end, a coefficient is determined for each parameter based on empirical data. The sensors are connected to a processor 50 programmed to multiply each sensed parameter times its coefficient and to sum the products of the multiplications to yield a predicted. The results produced by the processor 50 can also be used to modify the display schedule stored in RAM 20 to take local theater conditions into account such as the above parameters or for example audience attentiveness. Audience attentiveness, interests, or demographics could be measured by encouraging the audience to respond to a quiz or game displayed on the theater screen. Instead of being used to modify the display schedule stored in RAM 20, the results produced by the processor 50 could be used to control one or more other processes at the theater on a real time basis under the control of a RTC 52 or to generate reports for use by the advertisers.

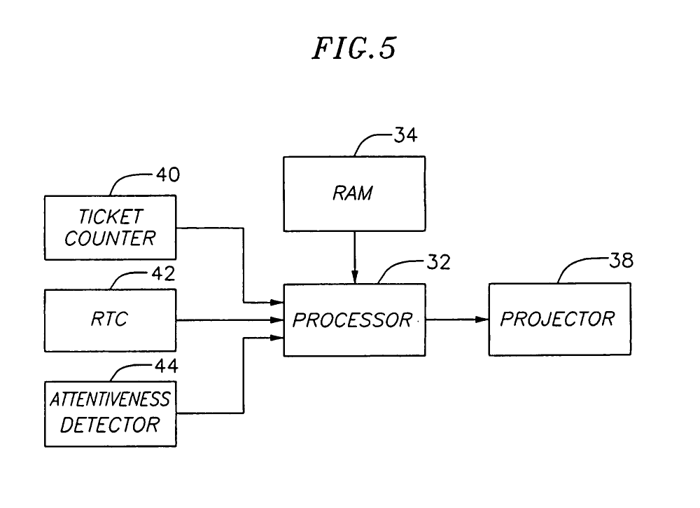

FIG. 5 illustrates an arrangement for modifying the advertising display schedule on the fly based on various conditions in a theater. A ticket counter 40, a real time clock (RTC) 42, and an attentiveness detector 44 are all coupled to processor 32. Counter 40 gives a count of theater tickets purchased or other reliable indication of the number of eye balls in the theater. RTC 42 gives the time of day. Attentiveness detector, which could use one of the approaches described above, gives a measure of the receptiveness of the audience to the advertisement being displayed. All three of these factors relate to the overall effectiveness of an advertisement displayed at the current time. Based on the rate paid by an advertiser, an appropriate time slot is selected by processor 32 and the advertisement is retrieved from ad RAM 34 for display by projector 38.

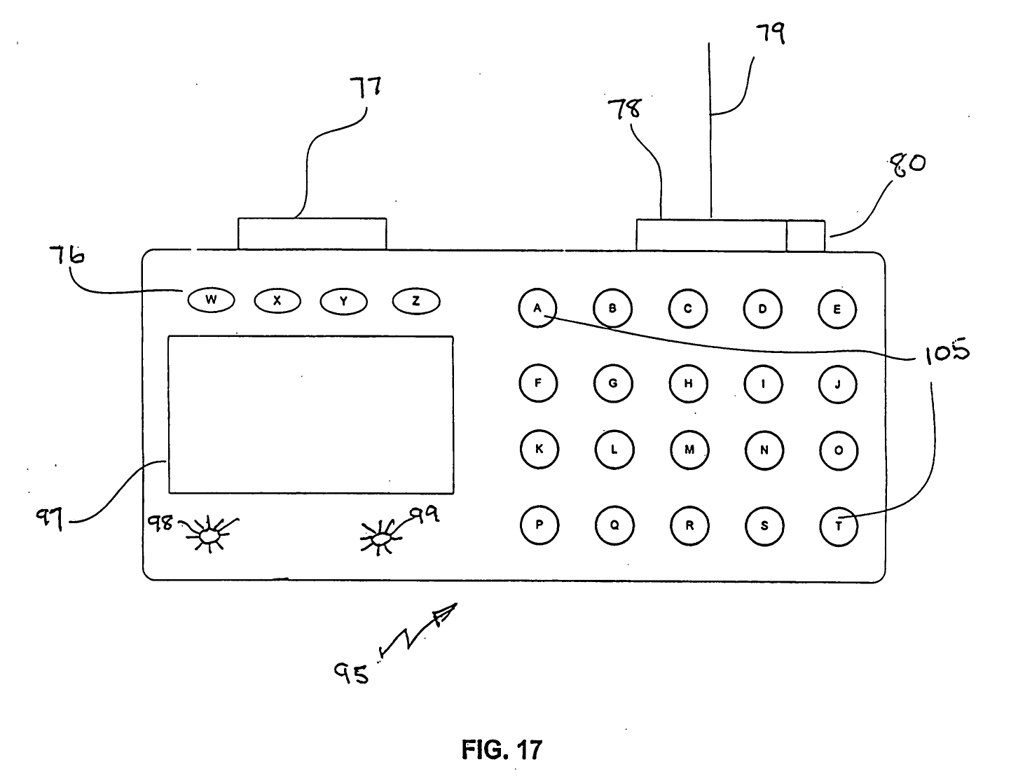

FIG. 6 illustrates various parts and elements of the present invention for producing interactive and appropriate media content to be displayed onto a theater movie screen 100 in an auditorium. The auditorium has patron seats 101 bounded by walls 102 and arranged in rows and columns as shown. A digital projector 38 (FIG. 5) is able to project onto screen 100 an image with sufficient resolution, brightness various data and video signals in several aspect ratios as desired. As compared to the present use of slide film projectors the digital projector is capable of being connected to a computer interface and display many different still and moving video and data signals onto the movie screen. Processor 32 (FIG. 5), including its programs and memory for carrying out the programs, is represented in FIG. 6 and subsequent FIG's as an In-Theater Controller 103. The programming that connects In-Theater Controller 103 to Internet 12 is not represented by the blocks in Controller 103. The digital projector 38 has an input connection 104 from the In-Theater Controller 103, which has the capability of displaying various data and video signals. This is advantageous in that it provides for more efficient utilization of the media content to be shown, as will become clearer from a further consideration of the invention. The In-Theater Controller 103 executes a number of programs illustrated by the blocks, namely a communication system 106 to manage input and output communication between each system and subsystem component, a loop management system 108 to control the loop features such as timing, length and content of the media to be shown via the input connection 104 to the digital projector 38, an interactive quiz/survey system 112 to control the questions and answer data in and output, a ticket interface system 114 to process ticket data and information, a projector control system 116, a log in system 118, a people counter system 120, an advertisement management system 122, interactive patron inputs from remote wireless transmitters (see FIG. 17) are processed through the dual addressable infrared grid (DAIG) controller interface system 124, a cryptologic system 126 is used to encode data and information, a survey system 128, and data redundancy system 130 used to back-up and monitor data storage and activity. In In-Theater Controller 103 (FIG. 6), there are other functions such as the ticket interface system 114, projector control system 116, advertisement management system 122, people counter system 120, cryptologic system 126, survey system 128, and all of the other necessary subsystems working in cooperation to deliver the optimal quiz question, sponsor message and or advertisement to the movie screen 100 processed by the In-Theater Controller 103 from input from sensors, database and rules.

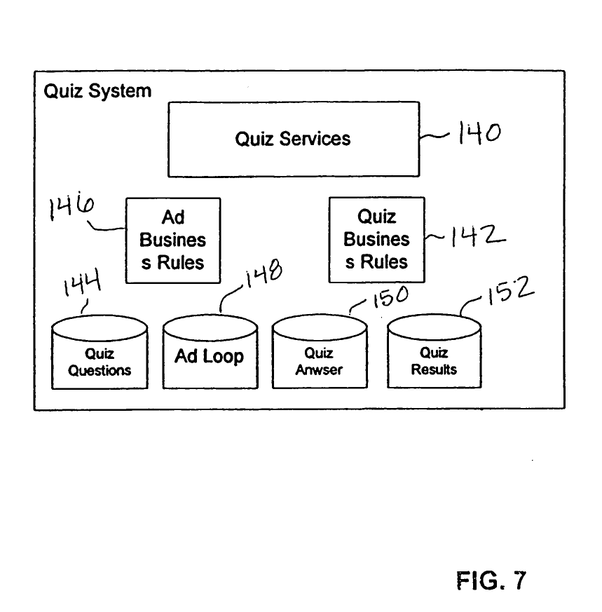

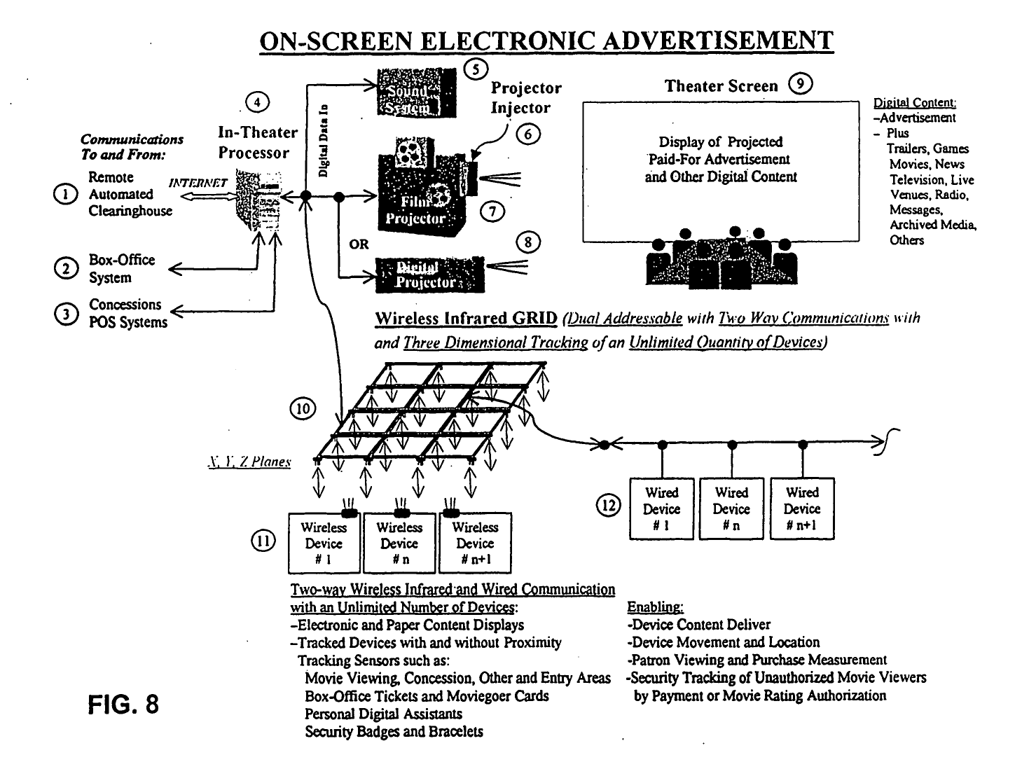

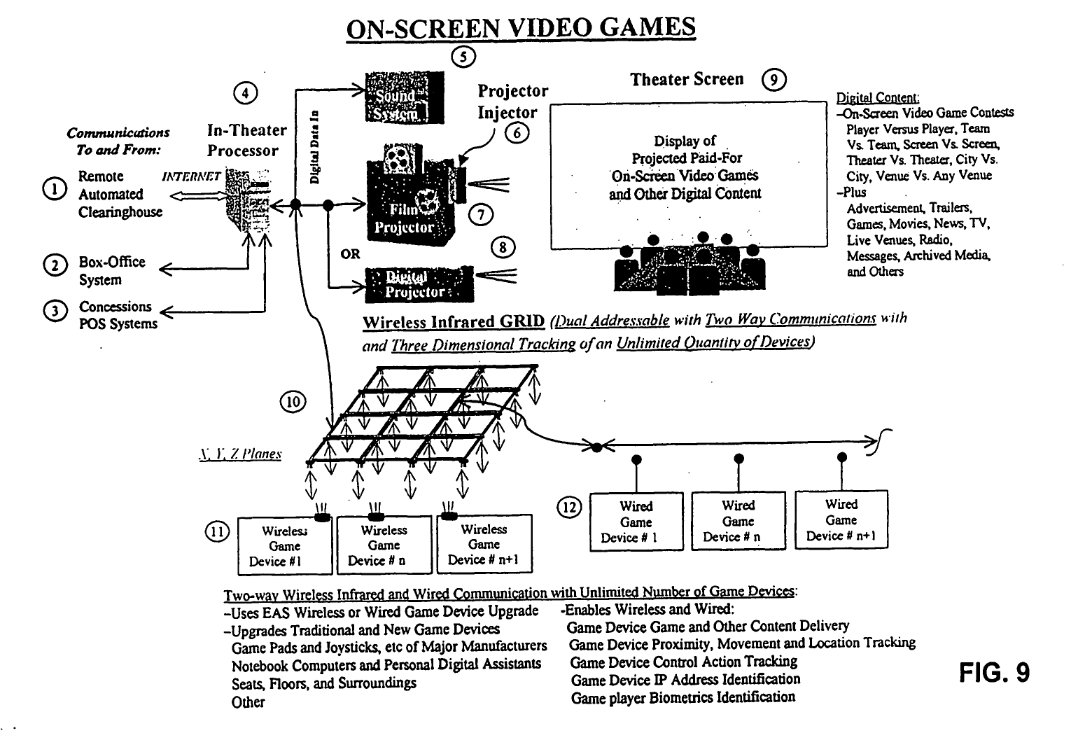

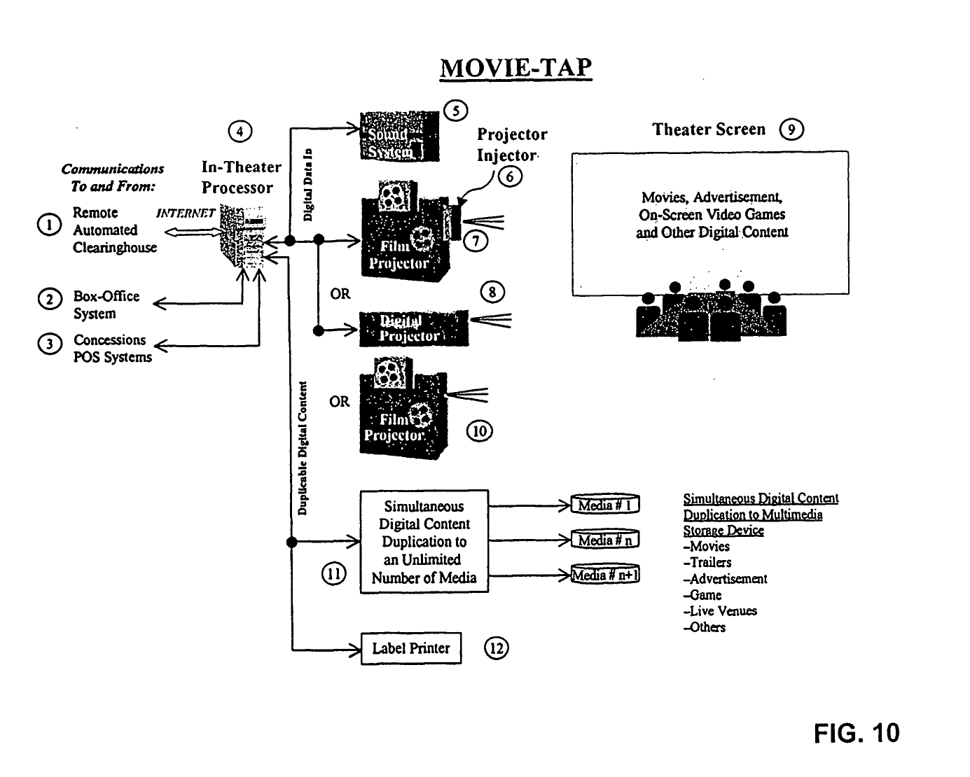

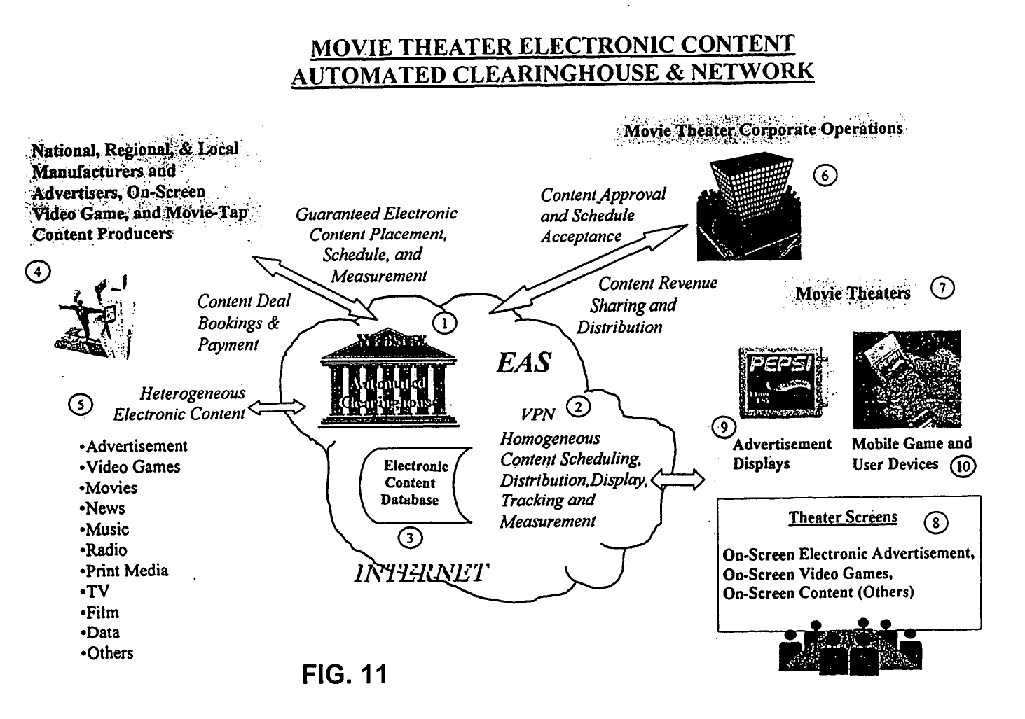

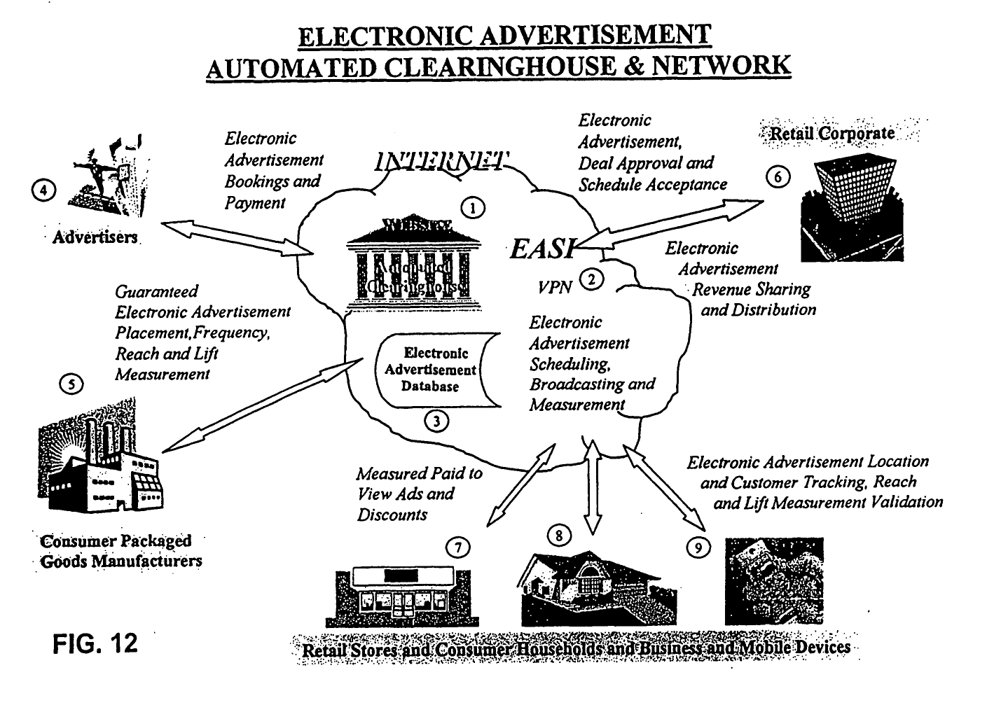

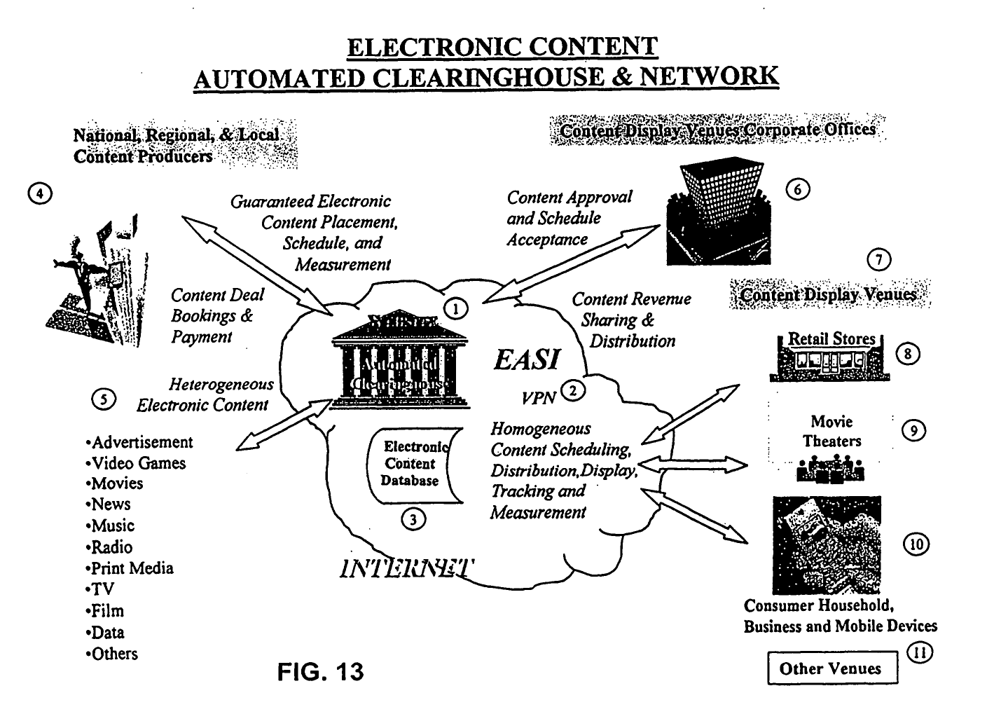

FIG. 7 depicts a data collection remote 95 with a keypad 96 for input of answer choices presented on a movie screen 100 as created by quiz/survey system 112 and In-Theater Controller 103 with a through input connection 104 to digital projector 38. The choices selected by the patron are entered into the quiz system 112 by the patron through alphanumeric keys 105 located on the data collection remote. On the remote a Liquid Crystal Display (LCD) 97 presents information, prompts, or special questions directly to the patron using the device. Reactions to the content displayed on the LCD located on the data collection remote are sent through infra-red transmitter and receiver diodes 98 and 99 located on the data collection remote and these radio signals are detected and received by the infra-red transmitter and receiver diodes on DAIG 132 and sent via DAIG interface system 124 as data via the Ethernet network 136 to the communication system 106 in the In-Theater Controller 103 and processed appropriately, for example as a quiz response the data is processed by the quiz/survey system 112 and quiz services software 140 represented in FIG. 7. The data collection remote 95 also includes the ability to use radio frequency transmitter and receiver 79 as another means to communicate data and information to the In-Theater Controller 103 system. Included in FIG. 6 is a electronic sensor 82, which permits the detection of a patron in a seat. Collection of the data regarding which seat is occupied or not is useful determining how many players are involved in a game, quiz, the attendance and viewing time of a patron which contributes to the potential value of advertisements and the price to be charged. The attendance and occupancy census can be compared to ticket sales or box office receipts and the data stored for use by the business rules systems. Remote 95 could comprise other handheld device types, such as a portable digital assistance, cell telephone, their combination and other devices, remote 95 has data and control inputs 105 used by the game player to direct and respond to video game play as it is projected onto movie screen 100, activity indicators 76 used to provide visual, audio and other sensorial feedback and activity to game player in conjunction with video game play, and wireless data and control port 77 and wired data and control port 78 used to provide communication with On-Screen Video Game System 9001 as previously described. Off the shelf industry standard game devices are interfaced to the On-Screen Video Game System 9001 by physical and electronic interface of wireless control and data port 77 and wired control and data port 78 portable adapters to the industry device's existing communication control and data circuit or ports. Optional video display indicator 97 is used to display visual content such as game play information and advertisement. Indicator 97 may be added to industry standard devices as required. Remote 95 is also used as an input and output device to interact with advertisement and other content as it is projected on movie screen 100 and on video display indicator 97. Similarly remote 95 may be used as an input and output device to interact with audio advertisement as it is projected via a theater sound system via interface and under control of the In-Theater Controller 103.

Once logged onto the system, game inputs 105 and display 97 and indicator 76 outputs of wireless remote 95 are interactively communicated via wireless radio signals 123 (FIG. 6) to and from the dual addressable grid 132 and with the In-Theater Controller 103 as described above. Video game play inputs 105 are processed by the In-Theater Controller 103 and the On-Screen Video Game System 9001 and ensuing affects are logged and shown on the video game projected on movie screen 100. Wireless remote display and indicator data and control commands are communicated from the In-Theater Controller 103 via Ethernet link 136 via DIAG interface 134 via dual addressable grid 132 via wireless radio signal 123 to wireless remote 95 display 97 and indicator 76 outputs. In addition to processing ongoing video game interaction and game activity display, the system constantly tracks remote 95 movements and location. Remote 95 continuously emits a tracking signal from tracker 80. As the wireless tracking signal 123 is detected and analyzed for strength, direction and proximity by the dual addressable grid 132, the electronic coordinates of remote 95 on the dual addressable grid 132 are communicated through the DIAG interface system 132 via Ethernet 136 to the In-Theater Controller 103, which logs the electronic coordinates versus time of day and date and creates a tracking record for device 95 within tracking system 9008. The electronic coordinates correlate to the physical location of device 95 in all three physical planes of the theater auditorium. This tracking and mapping process continues for all wireless device 95's while logged onto the system. A similar process is used to track wired remote 95'=s. Additionally anything equipped with a tracker 80 may be tracked by the system.

A grid of wireless infrared transceivers 132 is installed in the ceiling above seats 101 to communicate with infrared transceivers at the individual seats such as 82. (Other modes of wireless communication could be used instead of infrared.) Each seat is equipped with sensors 82, keyboards, and/or displays (FIG. 17) so the patron in the seat can communicate with In-Theater Controller 103. The individual transceivers of grid 132 are assigned unique addresses and individual seats 101 are also assigned unique addresses. Each communication between an individual transceiver and seat thus includes two addresses to route signals and locate the source of signals as described in DeTemple et al U.S. Pat. No. 5,572,653. Each seat sensor could send a signal indicating that it is occupied and where the patron is located by row, seat number etc. Grid 132 is connected by a cable 133 to a DAIG controller 134, which prepares the signals generated by grid 132 for transmission over an Ethernet network 136 to In-Theater Controller 103, such as seat sensors 82 and or patron input and output devices. Additionally, a patron is able to respond to information such as quizzes that are displayed on the movie screen 100 by inputting a response which is then communicated by infrared signaling to the dual addressable grid 132 and DAIG 134 through Ethernet network 136 to the DAIG interface system 124 in In-Theater Controller 103 via communication system 106 where it is processed in quiz system 112.

In In-Theater Controller 103 (FIG. 6), there are other functions such as the ticket interface system 114, projector control system 116, advertisement management system 122, people counter system 120, cryptologic system 126, survey system 128, and all of the other necessary subsystems working in cooperation to deliver the optimal quiz question, sponsor message and or advertisement to the movie screen 100 processed by the In-Theater Controller 103 from input from sensors, database and rules.

The control command, data and video signals for display are sent to the digital projector 38 from the In-Theater Controller 103 by link 104. Data and video inputs are collected and processed using the data and information from sensors, keypads, business rules and database, etc. as described herein.

In FIG. 7 more detail is shown regarding the quiz/raffle system 112. The functions of quiz system 112 are controlled by quiz services software 140, which include applying relevant rules to the quiz questions being presented to patrons. Specifically, quiz business rules software 142 govern the quiz questions and answers, which are most appropriate for the particular audience using parental control categories. The level of difficulty and how closely the quiz questions are related to the media content being shown in the auditorium that day or for the movie that the patrons have decided to attend. Elements 144, 148; 150, and 152 represent disk drives or other large storage devices. Having relevant quiz content that is able to increase the participation by patrons through interactive feedback using the quiz questions 144 benefits the patrons and sponsoring advertisers because of the increased participation and interest in the quizzes displayed on screen in the auditorium. More interactions and increased interest by the patrons translates into more awareness, exposures and recall of the quiz and products(s) being promoted. Each of the quiz questions from quiz question database 144 is run for a length of time and from an advertisement loop database 148, which has each advertisement and the known content running period for which each advertisement is displayed.

From the advertisement loop database 148 relevant and appropriate advertisement messages are stored for insertion into a quiz or other promotional display on the auditorium movie screen 100. The quiz answer database 150 collects ands stores the answers from the audience patrons in the auditorium of the theater during a quiz activity. The patrons answer quizzes through input devices communicating to the dual addressable grid 132 and then to the In-Theater Controller 103 to be processed by the quiz system 112 and then stored in the quiz results database 152. As can be seen, quizzes are one of many forms of interactive communication that are enabled by the invention and that are able to be changed as desired based upon the quiz business rules software 142. Quiz/raffle system 112 can also be designed to control advertising content. Advertisement business rules software 146 governs the display of products being advertised, for example not showing certain goods to specific audiences. Alcohol and tobacco advertisements would not be displayed to younger patrons or those attending a movie with a certain rating or family friendly genre.

The architecture of FIG. 7 could also be used to implement the on-screen video game (OSVG) feature. In this case a OSVG business rules are substituted for quiz business rules 142, an OSVG loop is substituted for quiz questions 144 and quiz answers 150, and OSVG results is substituted for quiz results 152.

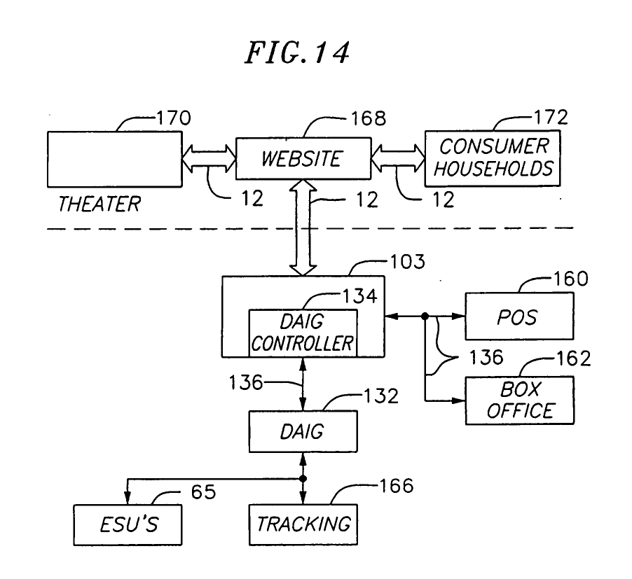

As shown in FIG. 14, a point of sale is located in a theater for the concession of items such as popcorn, candy and beverages. Each concession area usually has a point of sale (POS) device 160 where each item sold is recorded. With the sale of each item a database of the sales is established on the point of sale device. These database records are then transmitted to via Ethernet network 136 to the In-Theater Controller 103 to be stored in an appropriate database and file format for processing of the information as it relates to the advertisement management system 122. Advertising management system 122 is programmed to project the most relevant advertisements onto the screen(s) through the use of the loop management system 108 and communication system 106 to display advertising images onto the screen using the digital projector 38. The quiz/raffle system 112 may be employed to offer a prize of popcorn for the patron with the most correct answers to the quizzes and/or each patron that participates. The increase of the number of popcorn buckets sold stimulates the demand for others to purchase popcorn. The system operates to communicate and stimulate demand for a concession and/or sponsors of goods or services. The In-Theater Controller 103 is also connected via Ethernet network 136 to the theater's box office 162 for ticket sales information. As tickets are sold for each movie being shown in the auditoriums, the data is stored for collection on the In-Theater Controller 103 and within the ticket interface system 114. This data is processed in the In-Theater Controller 103 to optimally select and present advertisements relevant to the genre, audience and inputs gathered by the In-Theater Controller 103 from various databases and sensors. As one example, patrons may enjoy a specific genre of movies and the next coming attraction is added into the advertisement loop being shown under control of communication system 106 and loop management system 108. This advertisement is processed by the projector control system 116 to be sent to the digital projector 38 via the input connection 104 for display onto the screen in an auditorium.

Electronic signage units (ESU) 65 display information to patrons in various locations, such as the vestibule, movie screen 100 and or auditorium entrances. As illustrated, this information is distributed to the locations by dual addressable infrared grid 132. In this case, grid 132 would extend outside the auditorium proper to the vestibule and other areas to be accessed by grid 132. Alternatively it could be distributed by hard wire (eg, Ethernet network 136). ESU's 65 displays static and/or full motion video images under control of the communication system 106 and In-Theater Controller 103 based upon relevant and appropriate input of sensors, rules and databases being processed. Each of the ESU's 65 is able to receive and send data as detected from tickets, patrons, identification badges or other devices permitted by the communication system 106 to send and receive data and signals from the dual addressable grid 132 or ESU's 65 equipped with transmitters. The information and data collected is useful to create advertisement business rules 146 and quiz business rules 142 and other interactive content for display onto the movie screen 100 in an auditorium of patrons.

Tracking hardware 166 in the form of infrared transmitters communicate with the dual addressable grid 132. The transmitters are installed on moveable persons or things within the theater to track their movement and verify their location. The signals representing the individual transmitters and their locations are sent to In-Theater processor 103 where the information is compiled for transmission to clearing house 10, for use in selecting the ads to be displayed on screen 100, or for security purposes. For example the correct ticket needs to be purchased for a specific showing of a movie. Motion Picture AA (MPAA) ratings can be enforced when a ticket for a movie that has one rating inappropriate for the one in which the patron is seated for viewing. R rated movies would not be appropriate for G rated ticketed patrons. The tickets themselves or the patron ID such as a frequent movie attendance cards have the ability to communicate to the dual addressable grid 132 to indicate that the patron may not belong in the auditorium for the movie or content being displayed. The ability to monitor and enforce MPPA ratings increases the likelihood that a parent would permit an adolescent to attend theaters also showing R rated movies. The tickets or cards would communicate through radio signals 123 to the dual addressable grid 132 and then the data is sent by Ethernet network 136 to the communication system 106 and processed by the In-Theater Controller 103. The data about the kinds and types of concessions, volume, etc is collected and linked to the patrons that are able to be distinguished by either data collection from admission tickets or through input and interactivity by participation with the quiz/raffle system 112, sensors 40, quiz questions 144, or DAIG interface system 124, as processed by the In-Theater Controller 103, and reaction to the content, images displayed on the screens and Ethernet network 136 throughout the theater. In this case, grid 132 would also extend outside the auditorium proper to the vestibule and other areas to be accessed by grid 132.

With the use of a movie tap (MT) 164 a patron may enjoy a movie and order a copy thereof immediately rather than waiting for the movie to be mass distributed in the future. The movie tap functions as method to deliver a recording of the theater interactivity from quiz system 112 and content and images displayed on the movie screen 100, including the ability to replay or view activity recorded through input devices through the dual addressable grid 42. For example a group game or quiz event is recorded for the use of the patron that participated or others seeking to experience the event at another time and place. The patron can replay the quizzes at home by using the movie tap 164 to deliver a CD or DVD. A distinguishing feature of the movie tap 164 is that it will deliver the media content from the format it was presented into the format desired by the patron, for example the movie being shown is a film and the movie tap 164 delivers it in a DVD format.

With reference to FIG. 14, the theater location is connected to corporate and other stakeholders over the Internet 12 through a website at clearinghouse 10 (FIG. 1) that features the use of a virtual private network (VPN). The VPN interfaces and connects to content databases 170 that contain media, images and data for use in all the projection and display components. All of these elements are accessible through a virtual private network 74 accessed over the Internet 12, typically a transmission control Internet protocol TCP/IP network communication means for sending and receiving files. Each of the files sent over the Internet 12 between clearinghouse 10 and the In-Theater Controller 103 may be encrypted and controlled by the cryptologic system 126. Stakeholders, including the theater corporation, receive up to the minute status reports of concession sales broken down into time increments as collected by POS 160, attendance receipts from the box office, patron demographics from quiz answers 150, and logs of the advertisements actually displayed at the theaters and the time of display, advertisement, promotion and sales event information. The invention permits the make up of the audience to be understood and content, images and information presented on screen to become dynamically monitored and modified on a real-time basis when desired.

In-Theater Controller 103 sends image files from databases 170 via the input connection 104 to the digital projector 38 for illumination onto the auditorium movie screen 100 so corporate and other stakeholders are able to direct their content submissions to the individual theater or chain of theaters and or specific auditorium movie screen 100, which can be influenced by input from each of the sources connected to the system via the Internet 12. For example input from individual and aggregated consumer household(s) 172 is able to influence when a movie, content, contest or program is available for viewing in a theater, the location of the event, or showing times. In addition, consumer households 172 and in theater patrons provide the inputs to create a database of consumer interest and activity for analysis to optimize theater operational efficiencies. In other words, the right movie is shown the right number of times at the best time of day for maximum patronage to the theater.

In summary, the Internet 12 connects all aspects of the theater operation—In-Theater processor 103, content databases, 170, and consumer households 172 through website 168 to exchange data and video images among these constituencies.

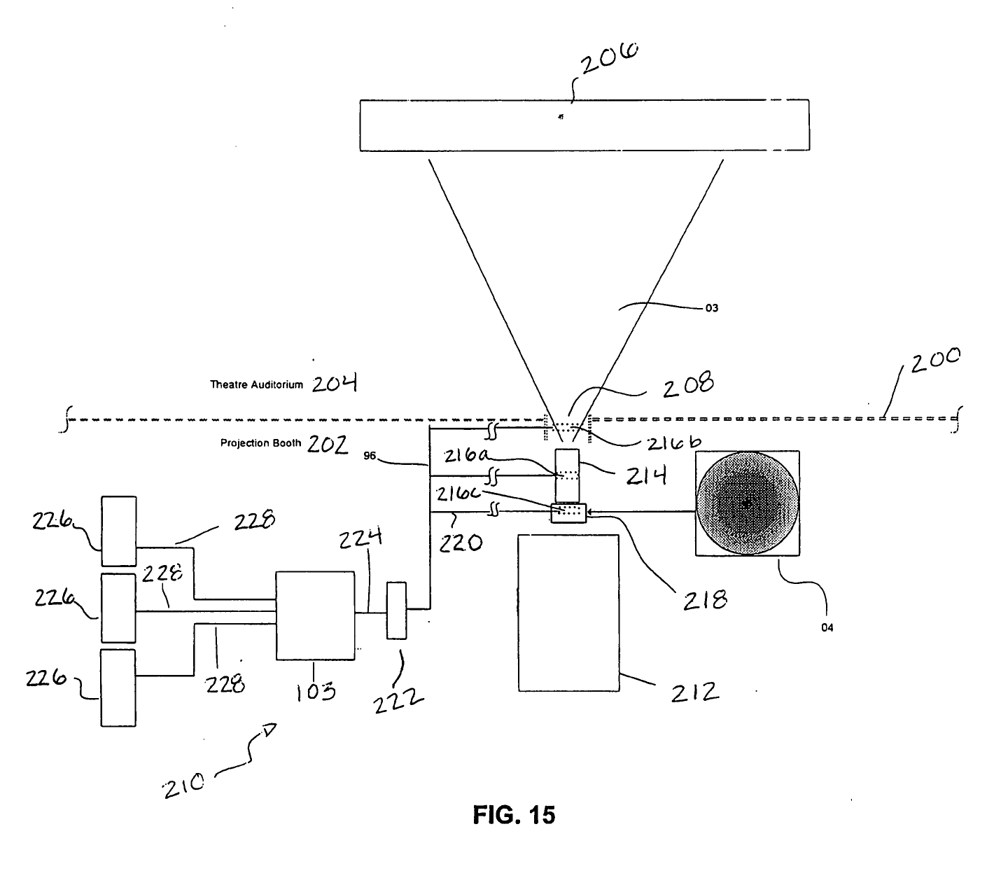

In FIG. 15 a separating wall 200 lies between a conventional projection booth 202 and a theater auditorium. 204, where the patrons are seated for the showing of the film onto a movie screen 206. The projected images pass through a clear glass window 208 located in the separating wall 200. An image injector 210 has an electronic display panel located at one of three positions directly in the path of the film projector's light source 212. The three positions are inside the projector's lens housing 214 at position 216a, after the lens housing 214 nearer the glass window 208 at position 216b, or behind the lens housing 214, but in front of the projector aperture plate and film track mechanism 218 at position 216c. The image injector 210 receives control and data via control and data lines 220 from the image injector controller 222, which receives its control and data via control and data line 224 from the In-Theatre Controller 103 (FIG. 6). The In-Theatre Controller 103 is connected to input sources 226, which comprise files of advertisements stored in RAM 34 (FIG. 5), via data and control lines 228. The In-Theatre Controller 103 controls the selection of the data and images forwarded via the image controller 222 to the electronic display panel. Thus, an electronic image is projected onto the movie screen 206 using the existing projector housing 214 and lens and the existing light source 212.

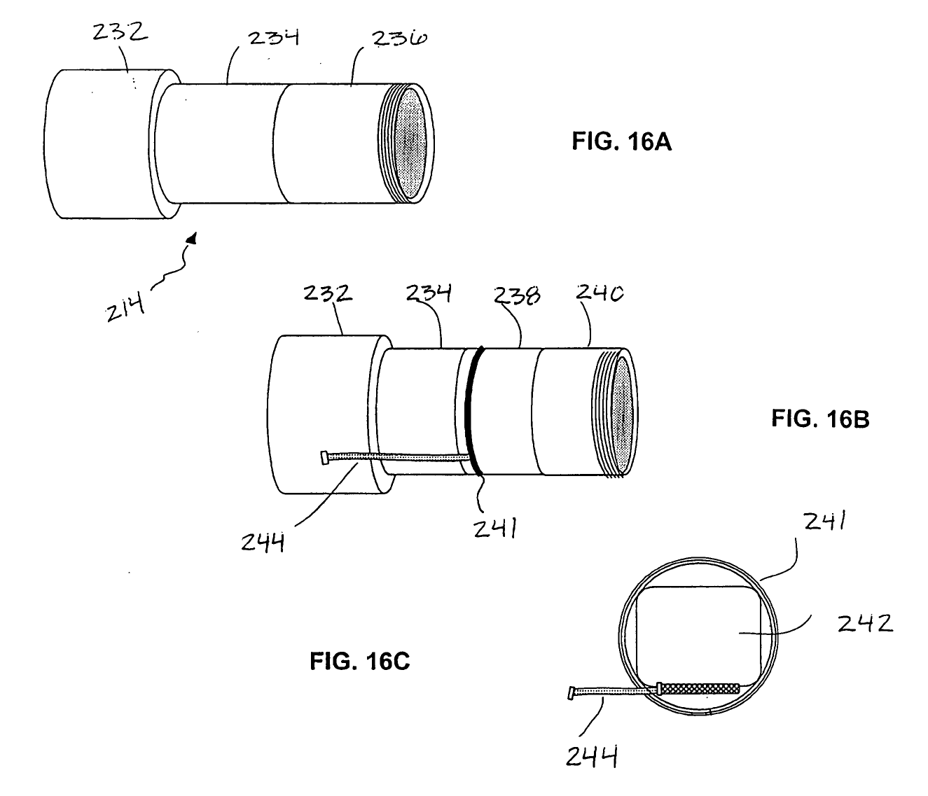

An exemplary construction of a conventional lens housing 214 is shown in FIG. 16A. Lens housing 214 incorporates multiple industry standard lens combinations such as lens sections 232, 234, and 236. Each theater auditorium has its own dimensions and screen size, thus the projector's lens housing 214 and lens sections 232-236 must be configured to project the proper image onto the movie screen 206. Once set, typical lens configurations rarely change, varying only by film aspect ratio. When the electronic display panel is at position 216a, the image injector 210 utilizes the conventional lens housing 214 modified to substitute lens sections 238 and 240 for lens section 236. A support ring 241, which holds electronic display panel labeled 242 is disposed in lens housing 214 between lens section 234 and lens section 238, as illustrated in FIG. 16B, and extends across the light path's lens housing 214, as illustrated in FIG. 16C. A cable 244 extends outside lens housing 214 to connect the electronic display panel 242 to controller 222. The electronic display panel 242 is capable of 100% transparency when an advertisement is not being displayed, in order to pass the motion picture film image through the lens system and through the window 208 onto the movie screen 206, and partial color-selective transparency, depending on the images of an advertisement to be displayed.

The invention contemplates several ways to insure that the light path from light source 212 through the lens to screen 100 is not obstructed by any images projected by the feature film being shown. One way is to unload the feature film from the projector reels while the advertisements are being displayed. Another way is to splice one or more sections of blank film into the feature film carried by the projector reels and synchronize the display of the advertisements with the blank film sections. When an advertisement is being displayed, an image thereof is formed on the electronic display panel 242 and projected onto screen 206. The electronic display and logic circuit 242 and cable assembly 244 is optionally retractable depending upon lens 214 configuration in order to ensure standard films can be shown. The projection of film or digital images is under control of the display schedule of the In-Theater Controller 103.

This adaptation is an advance in state of the art image projection because the image injector 210 enables operators to project traditional film and digital content onto existing movie screens 206 by using the existing light source 212 and other installed projector subsystems. This negates the need to purchase expensive digital content only projection systems whose very installation also eliminates the operator's choice to show traditional film only releases. The image injector enables theater operators to alternate between and combine their choice of digital content and traditional film projections. This enables the operator to offer and secure additional revenue from multiple forms of new and old entertainment content. The projector injector 210 protects the operator's current equipment investment, expands useful equipment life, and adds here-to-unaffordable digital projection capability.

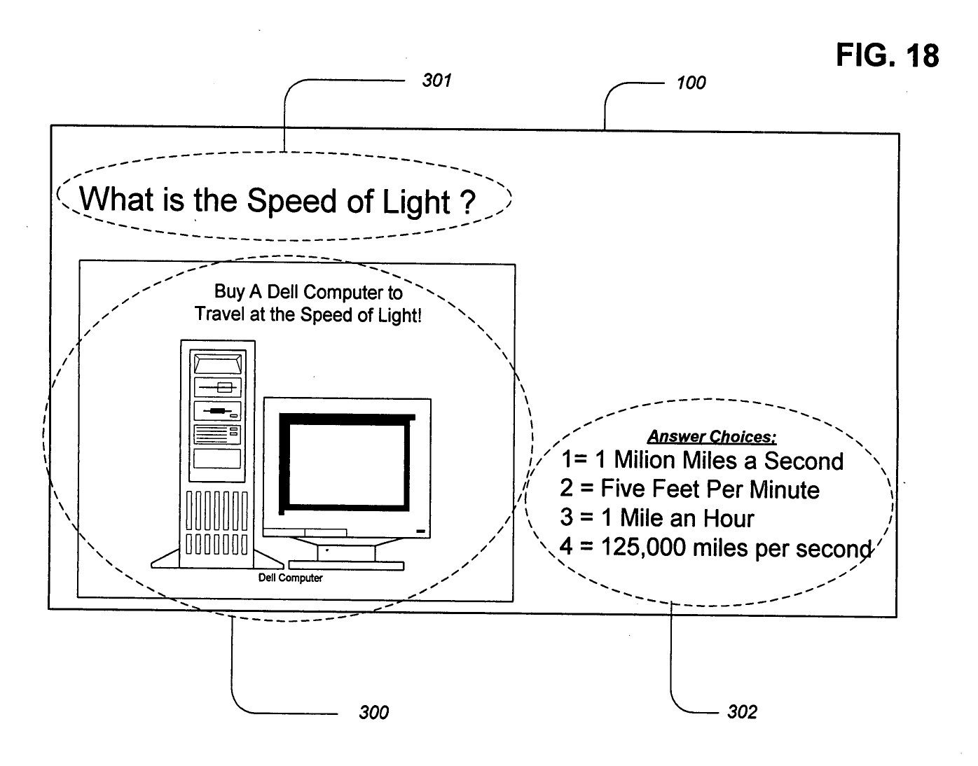

FIG. 18 is an illustration of an example of the image output of the In-Theater Controller 103 and quiz system 112 sent to the digital projector 38 and shown on the movie screen 100. The example quiz advertisement image 300 shows a question 301 above the example quiz screen answer choices 302, these choices are the ones to be entered onto the data collection remote 95 using the alphanumeric keys 105 located on the keypad 96. In this example the advertisement is for a personal computer.

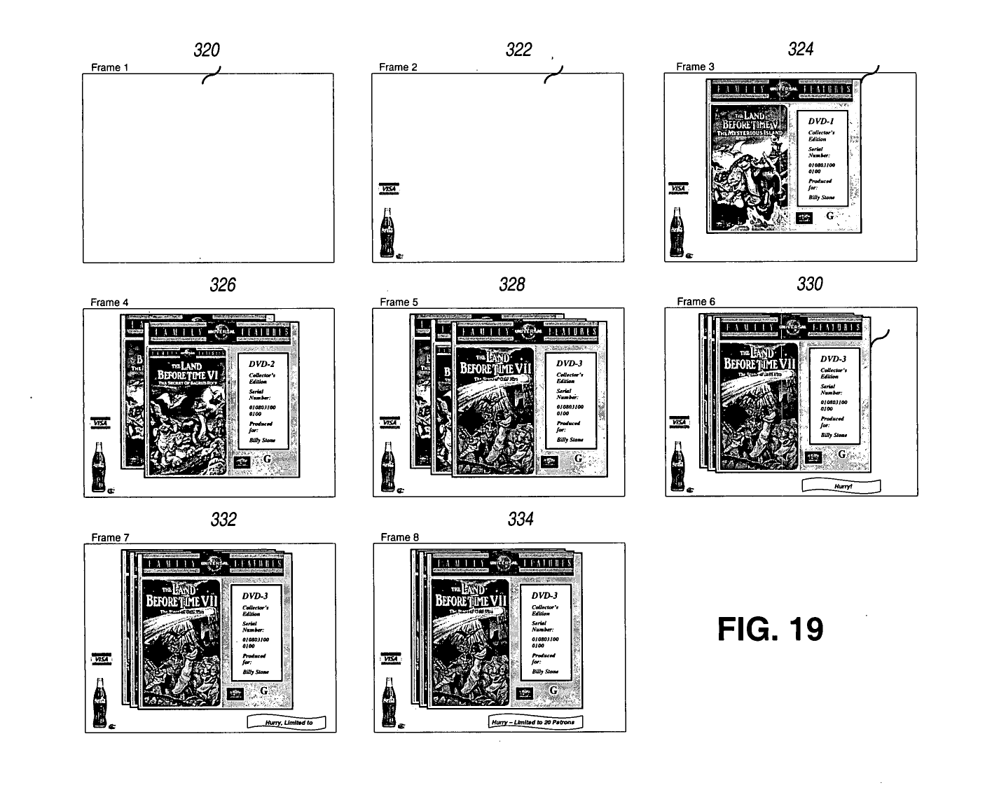

FIG. 19 shows the example of a In-Theater Controller 103 directing the display of an image through the input connection 104 to the digital projector 38 in order to display an image on the movie screen 100 in the auditorium of a theater. The first frame is blank except for the copyright legend in small print, the first frame 320 with copyright is then followed by the second frame which displays the sponsor frame 122 then the a larger first advertisement 324 image then a second advertisement 326 image, a third advertisement 328 and then a fourth advertisement 330, then a fifth advertisement 332 and finally a sixth advertisement 334 image frame, progressively each frame is shown and the content in the frames and sponsorships are changeable as desired through the In-Theater Controller 103 sending the image signals to the input connection 104 on the digital projector 38. Each frame is able to have different sponsors or advertisements and the advertisements and images may be presented as a slide show or as full motion video as these signals are controlled by the In-Theater Controller 103 as connected to the digital projector 38. This is a great advancement over the use of a slide carousel and a great cost savings for theaters that desire to have digital advertising images efficiently projected instead of a feature film using an existing light source.

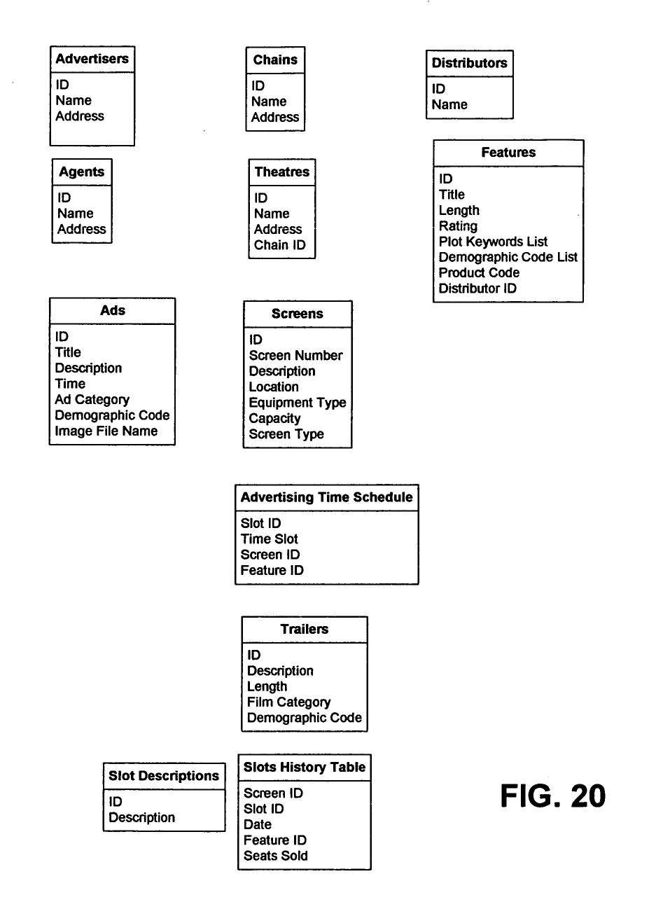

FIG. 20 shows the data fields of a number of blocks of information used in the practice of the invention.

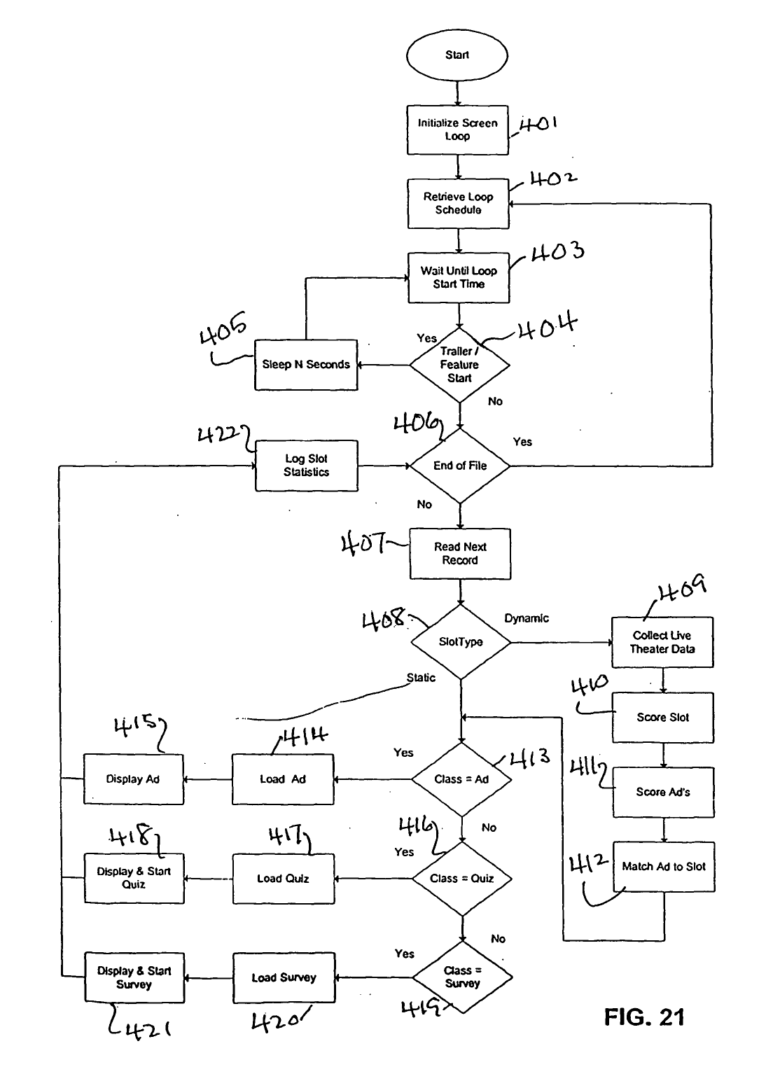

FIG. 21 shows a flow chart for the Advertising, Quiz and Survey process steps in the flow of the processing and logic for displaying a particular advertisement or image based upon specific data feed from the input databases and compared to the actual input of the activity or characteristics of the audience, theater or content being show as the main feature, etc. Specifically, from the starting state of the processor or machine the routine moves to block 401, which represents the initialization of the screen loop, i.e., the actual images to be displayed on screen; block 402 represents the retrieval of the loop schedule, i.e., pre-established or dynamic loops of images to be shown are retrieved for displaying on screen at the appropriate time and sequence, e.g., previews, intermission and trailer (end of feature); block 403 represents a wait until loop start time, i.e., the prescheduled or dynamically configured images are in a waiting state ready to be displayed upon cue for either a trailer or feature event; block 404 represents a trailer or feature start decision point, i.e., yes display feature; if it does not display then the processor sleeps and awaits another trailer of feature starting event; the advertisement loop or quiz activity ends just before the feature starts and after the loop plays upon the trailer activity; block 405 represents processor sleeps until another trailer or feature point arrives to start the loop; block 406 represents the end of file routine decision, i.e., if yes the appropriate loop is retrieved or created to be shown; block 407 represents next record is read; block 408 represents decision process by the logic for static or dynamic advertisement inserts decision; block 409 represents processing of data inputs that are collected from real time (live) sensors such as seat sensors and other communication inputs to the system; block 410 represents the ratings or responses or appropriateness based upon the audience, venue, time of day, audience characteristics and past behaviors or history, and number, quantity and type of audience demographics are rated or scores kept to compare the advertisement's performance or audience appreciation or retention is compiled as a score for that time slot or genre slot; block 411 represents advertisements scored based upon inputs from data collection devices and sales or responses to the advertisement's call to action; block 412 represents each advertisement is compared for appropriateness for being shown at a specific slot time, for example new automobile advertisements can be shown to the appropriate audience that the car is created for or specifically the demographic the auto should or may appeal to, or adult products can be advertised during R movies and for PG movies general merchandise is more appropriate or based upon the sales attributable to the audience or group; block 413 represents that each advertisement may be classified as a display advertisement, part of a quiz or survey requiring input from the audience members which in turn adds to the data for an advertisement; block 414 represents that an advertisement is loaded to be projected as an image; block 415 represents in this case an advertisement is shown; block 416 represents selection of a quiz with or without an advertisement or sponsorship; block 417 represents loading of a quiz; block 418 represents display and start a quiz routine; block 419 represents that a survey is selected; block 420 represents that a survey is loaded; block 421 represents display and start of the survey on the screen as an image; and block 422 represents the activity about the audience and inputs being logged into the database for statistical analysis.

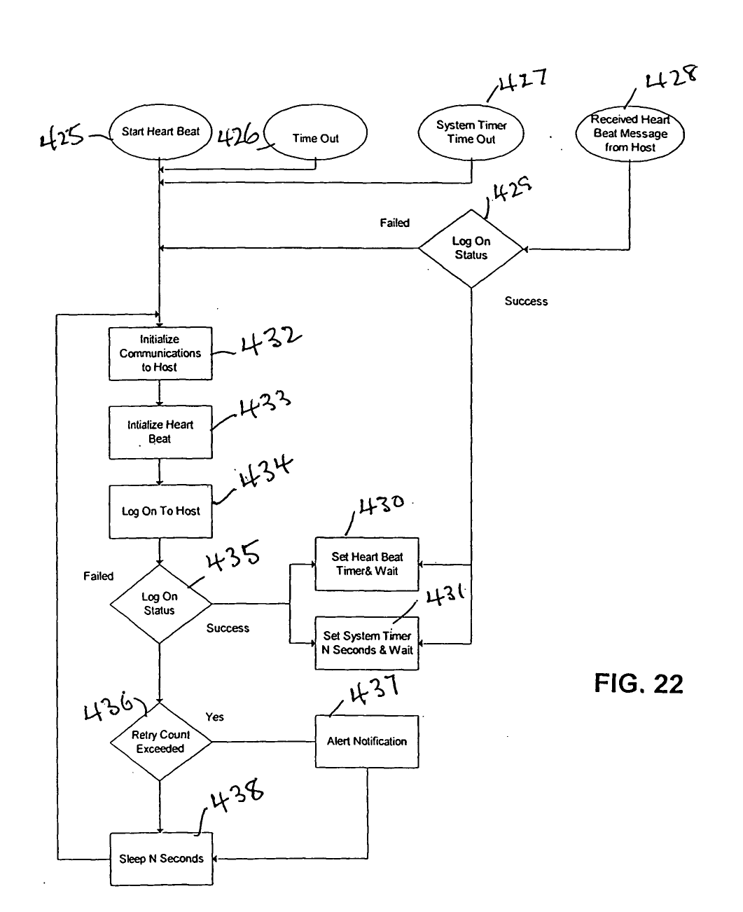

FIG. 22 is the software or firmware routine for communication with input devices and software routines between system components such as In Theater Processor 103, audience communication devices etc. Specifically, block 425 represents start of the processor acting on a software routine or the “on” activity or “awake”; block 426 represents routine or processor “awake” no activity so the time out moves the unit to sleep and periodically awakes to check for a start signal; block 427 represents the system as been either not awakened for a set number of cycles or move to a power saving off when idling for a extended length of time without an interrupt; block 428 represents that the host provides a wake up call to start activity; block 429 represents decisions of logging into the host computer for communications with other devices or peripherals; block 432 represents initialize communication with the host, i.e., the host and remote are beginning the communication handshake, agreeing on communication style, error correction and rate to transmit and receive data; block 433 represents that the communication begins; block 434 represents that the host logs on with the remote device communicating; block 435 represents the decision that the log on procedure either failed or succeeded; block 430 represents a synchronization condition for data transfer, and timers for events and wait status are set; block 431 represents that system synchronization settings are inputted; block 436 represents a failure to log on, retry count exceeded as set; block 437 represents failed log attempts so an alert is sent for display to the operator; and block 438 represents input setting for sleep cycle or power saving controls.

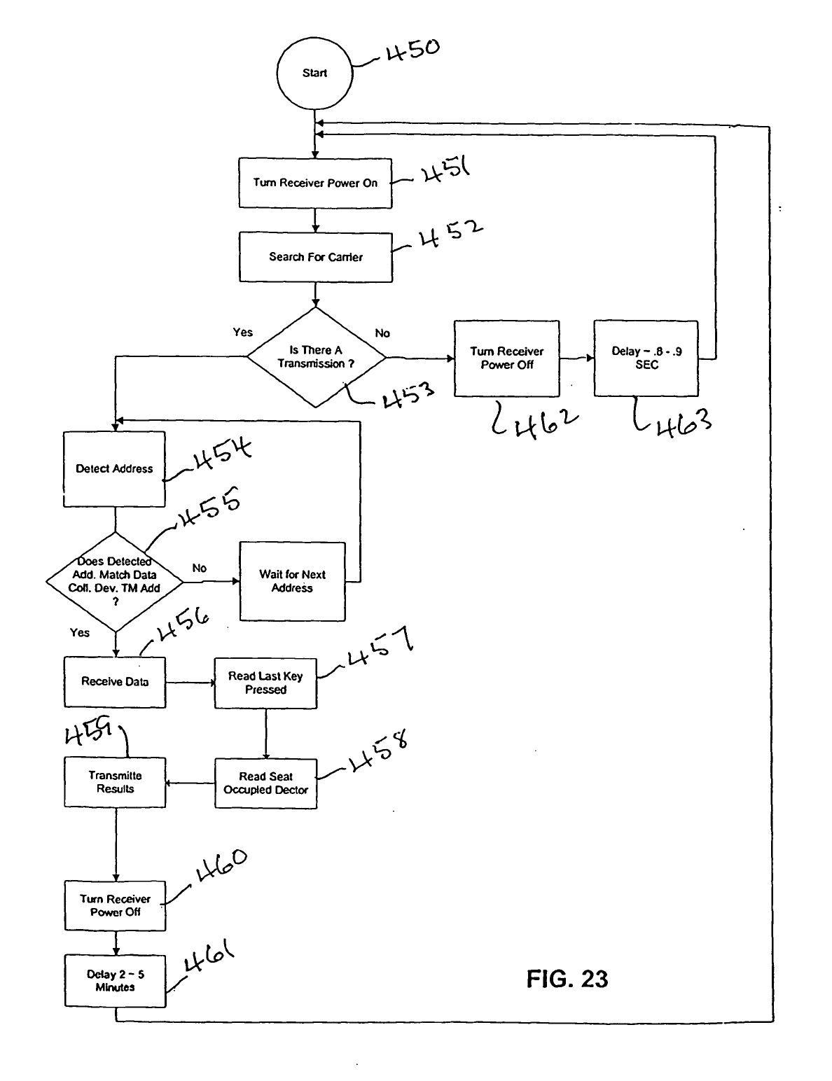

FIG. 23 displays the flow chart and process of communication with audience communication devices via the infrared grid 132 or other means that tie the inputs back to In-Theater Processor 103 or other system data and database collection features. Specifically, block 450 represents the start of the processor acting on a software routine or the “on” activity or “awake”; block 451 represents the infrared grid receiver or other input means from the audience communication devices being powered “on” and active ready to transmit or receive communications; block 452 represents searching for a carrier signal, i.e., for an open line or open channel to carry the data; block 453 represents the decision of whether there is a transmission being sent or received; block 454 represents a Yes decision, transmission being communicated so an address must be detected as to the source of the transmission or destination of the signal and data; block 455 represents the decision of whether the detected address matches the data collection device, terminal address of the devices known to be actively registered or in the systems database; block 456 represents that addresses match and data can begin to be sent; block 457 represents that the last key pressed is read for a cue to check the seat occupied detector to be certain the patron is in the seat or it is occupied; block 458 represents that the seat occupied sensors detection status is noted; block 459 represents that the results are sent to the host; block 460 represents that the receiver is powered down after the transmission and communication activity to save power; block 461 represents that an adjustable delay occurs before power is reduced to sleep or wait status of the communicating devices; and the loop back to block 451 represents that as each device is processed, the next address is looked up in the database and compared with the address of the device for a match; if there is a match the cycle is repeated; block 462 represents that receiver power is turned off while there is no transmission, or in a sleep or power save mode so that any interrupt awakes the unit; and block 463 represents that there is a time delay in the cycle of shutting down progressively.

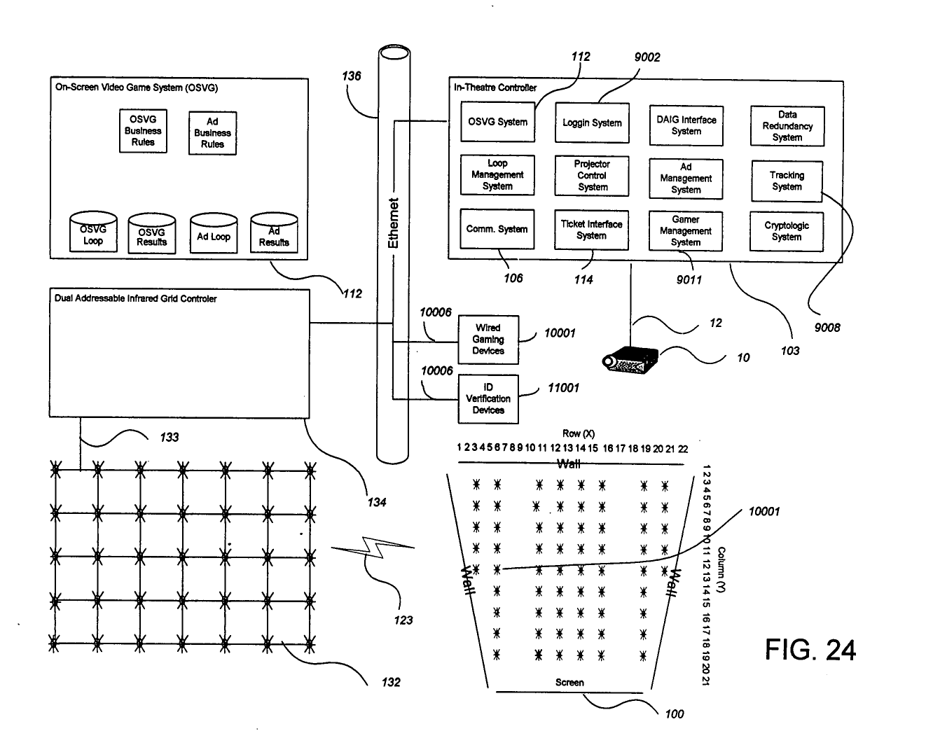

FIG. 24 is an illustration of the disclosed system elements of the On-Screen Video Game System 9001. The invention expands the theater auditorium into an entertainment gaming center whereby the auditorium's movie screen 11 displays video game and game player activity, replacing the traditional CRT, or the like, display. Video games are projected onto the movie screen 11 by projector 10 under the control of the In-Theater Controller 14 via control and data line 12. Game player devices, in this embodiment example remote 95, activity and physical location and movement is tracked, integrated into the video game play and displayed on the movie screen 11 by the In-Theater Controller 14. The number of remotes 95, each having a unique device identification number, thus game players, each also having their unique player identification number, on movie screen 11, addressable by the wireless dual addressable grid 132 is 1,000,000. All remote 95 location and movement is tracked in three-dimensions and correlated in time by the system via the wireless dual addressable grid 132. A key element of the solution enables multiple same game B video game players, utilizing remote 95, or the like, to interactively compete against one another on the same single video display, movie screen 11. Another key element of the solution enables concurrent display of multiple video games being played by multiple players using remote 95, or the like, through the split screening of movie screen 11. Theater audio sound system 20001 is interfaced to the In-Theater Controller 14 to provide video game and content sound reproduction.

Communication interface from the On-Screen Video Game System 9001 to remote 95 may be wireless, direct-wired and/or both, depending upon the remote 95 and the video game. For wireless remote 95 interface, the In-Theater Controller 14 communicates data and control information to and from the remote 95 via Ethernet network 136 via DIAG interface system 134 via wireless dual addressable grid 132 via wireless radio signals 123 to wireless remote control and data connection port 77. For wired remote 95 interface the In-Theater Controller 14 communicates data and control information to and from the remote 95 via Ethernet network 136 to control and data connection line 10006 to wired remote control and data connection port 78.

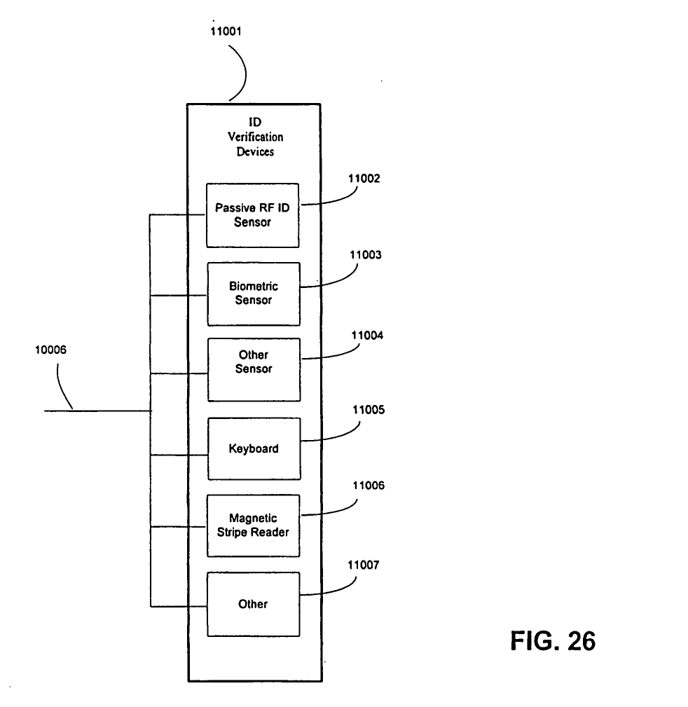

FIG. 26 is an illustration of the disclosed elements of the On-Screen Video Game System's ID Verification Devices 11001. To enter a theater auditorium and play a video game, a game player must log onto and be positively verified in real-time by the solutions Loggin System 9002 (FIG. 24). This ensures only eligible game players compete in the video game projected on the movie screen 11. The ID Verification Devices 11001 subsystem communicates with passive RF-ID sensors 11002, biometric sensors 11003, other sensors 11004, keyboards 11005, magnetic stripe readers 11006, and other physical devices 11007 and via control and data line 1006 via Internet link 136 with the In-Theater Controller 14 and Loggin System 9002. One authorization and verification scenario would have the passive RF-ID sensor 11002 automatically recognize the unique RF-ID identification tag number implanted in the game player=s identification card, or secured to his remote 95, or imbedded in an admission ticket, or the like. The game player would then enter his unique personal identification number on a keyboard 11005 and the information would be communicated via data and control line 10006 via the Ethernet 136 to the In-Theater Controller 14, where the Loggin System 9002 would validate and authorize game play for the game player. Another scenario would have the game player insert his finger, or the like, into a biometric sensor 11003 and then enter his unique personal identification number on a keyboard 11005. This information would be communicated via data and control line 10006 via the Ethernet 136 to the In-Theater Controller 14, where the Loggin System 9002 would validate and authorize the game play for the game player. Still another scenario would have the game player actively swiping his identification card through a magnetic stripe reader 11006 and entering his unique personal identification number on a keyboard 11005. This information would be communicated via data and control line 10006 via the Ethernet 136 to the In-Theater Controller 14, where the Loggin System 9002 would validate and authorize the game play for the game player. Still other scenarios would utilize various combinations of the above ID Verification Devices 11001 in order to create real-time, positive verification and authorization of game players.

Game player logon authorization will not be finalized via Loggin System 9002 unless the game player has paid for or pre-authorized funds transfer for game play payment. If Loggin System 9002 determines the game player has established play credits based on previous game play, pre-payment or payment via Ticket Interface System 1149, game player verification and authorization is granted via the In-Theater Controller 14 via the Ethernet 136 via data and control line 10006 to ID Verification Device 11001 to other physical device 11007; e.g., a federal regulation E printing device. If Loggin System 9002 determines the game player needs to pay, game player verification and authorization is not granted and the game player is advised at physical device 11007; e.g., a federal regulation E printing device. At this time the game player is also directed back to the theater=s ticket office to make payment or prompted for payment method, such as a credit card, debit card, or other authorized electronic payment type. Game player inputs a secure electronic payment authorization request via ID Verification Device 11001 and communicated via data and control line 10006 via the Ethernet 136 via the In-Theater Controller 14 via Loggin System 9002 via Ticket Interface System 114, formatted for a appropriate electronic funds transaction and transmitted via Comm. System 106 via the appropriate external financial authorization network. Upon receipt of electronic funds transfer authorization via Comm. System 106, the Loggin System 9002 stores game player payment information, authorizes play, and communicates required electronic funds transaction and game authorization status via the In-Theater Controller 14 via Ethernet 136 via data and control line 10006 to ID Verification Device 11001 to other physical device 11007; e.g., a federal regulation E printing device.

Upon authorization a game player is electronically linked to the remote 95 he is using to play the video game. The On-Screen Video Game System 9001 then assigns a unique IP address to the game player based on this linkage and this unique IP address is utilized to identify ongoing game player tracking and video game play. This is done for all game players. This identification and game play tracking process is a key element of this invention because it also extends movie screen 11 video game play to non-theater auditorium-based, remote IP address game players. These authorized remote IP address game players, connect to the In-Theater Controller 14 via Internet, LAN (local area network), or other means, and they are identified and tracked by their device's (computer, PDA, cell phone, etc.) unique IP address, similar to how Internet-based and LAN-based computer-to-computer video games are currently executed. For example, a remote Personal Computer-based game player and his game play will be linked by his computer's IP address through the Internet through In-Theater Controller 14 through Comm. System 106, to the On-Screen Video Game System 9001. As the In-Theater Controller 14 projects the video game onto the movie screen 11, it includes the interaction of all IP address based game players, both in-theater auditorium players and, in this example, a remote PC-based remotes. Additionally, utilization of IP addresses to identify game players enables multiple game players to compete on multiple movie screens 11 via the Internet, LAN, or other interconnection of multiple In-Theater Controller's 14 that are executing and running the same video game on their respective On-Screen Video Game Systems 9001; e.g., single or multiple game players on one movie screen 11 can compete with any number of other game players on any number of movie screens 11 or on other displays, such as a remote PC's monitor. Additionally the video and audio advertisement content and processes detailed in other sections of this disclosure can be used with video games.

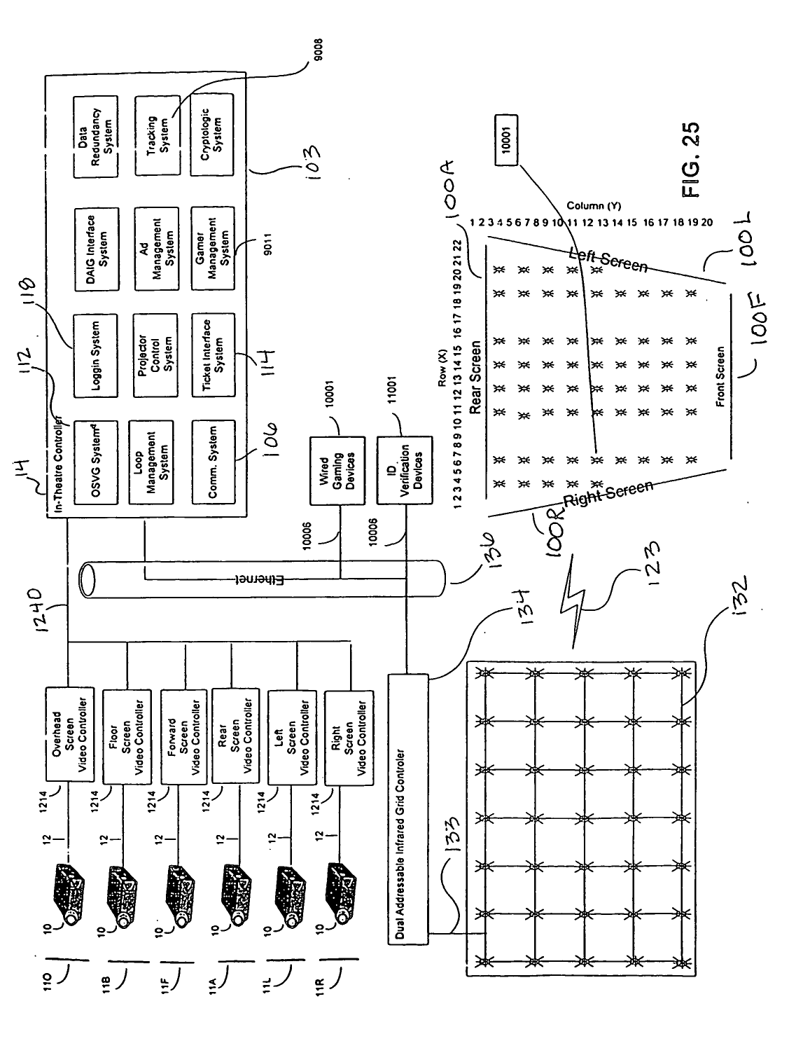

Another element of the invention as illustrated in FIG. 25 is derived by the utilization of the dual addressable grid 132 and the In-Theater Controller 14 with multiple Screen Video Controllers 1214, multiple projectors 10, and multiple movie screens 11O-11R to create a three dimensional player-centric immersed video game space within a single theater auditorium or space. Each wall, the ceiling and the floor are outfitted with movie screens 11 covering their entire area, creating a six-sided or cubed enclosure. The dual addressable grid 132 is integrated with the ceiling movie screen 110. A Screen Video Controller 1214 is assigned to a projector 10, and a projector 10 is assigned to each of the six movie screens 11O-11R. Each Screen Video Controller 1214 communicates video game and game play content from its On-Screen Video Game System 9001 via control and data line 12 to its assigned projector 10, which projects the video game and game play content onto its assigned movie screen 11. Each of six movie screens 11O-11R display different video game and game play images in order to create a player-centric perception of surround or immersed video. The On-Screen Video Game Systems 9001 in each Screen Video Controller 1214 is dedicated to deliver only the appropriate player-centric immersed video game and game play content applicable to the location of its assigned movie screens 11; e.g.: the ceiling movie screen 110 displays only video game and game play images that would be perceived as such by a game player if he were looking upward; the forward movie screen 11F displays only video game and game play images that would be perceived as such by a game player if he were looking forward; the floor, rear, right and left movie screens 11B, 11A, 11R, and 11L, respectively display only video game and video play images that would be perceived as such by a game player if he were looking to the floor, to the rear, to the right, or to the left, respectively. The In-Theater Controller 14 used in this player-centric immersed video game solution performs all of the functions previously detailed for other In-Theater Controllers 14, excluding direct control of a projector. Additionally the player-centric In-Theater Controller 14 processes all video game and video game player IP addresses identification and tracking information, synchronizes it for each Screen Video Controller 1214, and communicates it to the Screen Video Controllers 1214 via data and control line 1240, Ethernet 136, or other suitable communication link, in order that each Screen Video Controllers 1214 may process and project synchronized video game and video game player activity on its assigned movie screen 11O-11R via control and data lines 12 and assigned projector 10. Further the player-centric In-Theater Controller 14 system can connect via Internet, LAN, or other means to unlimited other multiple player-centric In-Theater Controller's 14 in order to enable multiple local and remote game players to compete in multiple six-sided three dimensional player-centric immersed video game spaces. Additionally the video and audio advertisement content and processes detailed in other sections of this document can be used with player-centric video games.

As used herein the term “feature film” includes not only film plays but also documentaries and films dealing with other subjects that attract paying patrons to a theater.

As used herein the term “motion picture” includes not only motion pictures resident on film but also motion pictures stored and projected electronically.

Current the industry standard is to use static advertisements stored on 35 millimeter color slides 2-2 that are project via a mechanical 35 millimeter slide projector 2-1. These slide projectors are activated manually by a manual switch; or by electrical timer and relay 2-8. When the motion picture film projector light system circuit 2-7 is closed (light on) the slide projector circuit 2-3 is opened, (slide projector off). When the motion picture film projector light system circuit 2-7 is open (light off) the slide projector circuit 2-3 is closed (slide projector on). The power to the circuit is supplied via 2-10 from the theatre power system. The projections from both motion picture film projector 2-4 and slide projector 2-9 are show on the same screen. (Do we need the name of the projectionist from Joe and Jeff's meeting a Universal).

The slide projector 2-1 contains a carousel 2-2 that contains a fixed number of slides 2-2. Typically 36 slides. The carousel 2-2 is rotated at a constant rate causing each slide to be displayed the same amount of time. Frequently the same sequence of slides is show over and over again because the carousel rotates 2-2 in a circle.

The first invention described is an automated electronic projection system (FIG. 3) using a computer 3-2 connected to a analog or digital signal projector 3-1-A, projector injector before the film 3-1-B or projector injector after the film 3-1-C that replaces the mechanical slide projector system (FIG. 2). The advertisements are stored in the computer 3-2 or on another computer (3-2-A, 3-2-B or 3-2-C) on the network in data files complying to industry standards such as jpeg, flash (TM Macromedia) and proprietary. The images can also be stored in non standard data files.

The computer application running on computer 3-2 is signaled electronically to activate the advertisement loop via an electronic photon sensor 3-12 or an electronic power detection circuit 3-8. The electronic power detection circuit 3-8 signals the computer application to stop the advertisement loop when the motion picture film projector light system circuit 3-7 is closed (light on). The electronic power detection circuit 3-8 signals the computer application to start the advertisement loop when the motion picture film projector light system circuit 3-7 is open (light off). The electronic photon sensor 3-12 detects when the light from the motion picture film projector light system 3-5 on. When the light is detected the circuit 3-12 signals the computer application to stop the advertisement loop. The power to the circuit 3-10 is supplied via 3-10 from the theatre power system. The projections from both motion picture film projector 3-4 and automated electronic projection system 3-9 are show on the same screen.

The number of advertisements is only limited by the capacity of the disk storage systems of the computers (3-2, 3-2-A, 3-2-B, 3-2-C) integrated with the motion picture film projector 3-4 or on the network 3-11. The advertisements can be shown for variable length of time and in unique sequence each time. The system (FIG. 3) supports animated advertisements with integrated sound 3-13 in addition to still advertisements.

What is claimed is:

1. A method for displaying video advertisements at a plurality of geographically separated theaters, the method comprising the steps of:
storing a library of video advertisements at a clearing house remote from the theaters;
connecting the clearing house to the theaters through a network;
transmitting video advertisements to the theaters over the network;
transmitting display schedules of the transmitted video advertisements to the theaters over the network;
projecting a feature film onto a screen at one of the theaters; and
substituting the transmitted video advertisements for the feature film being projected at said theater so the transmitted video advertisements are displayed on the screen according to the schedules.

2. The method of claim 1, in which the connecting step connects the clearing house to the theaters through the Internet.

3. The method of claim 1, in which the step of transmitting display schedules transmits a different display schedule to each theater.

4. The method of claim 1, in which the step of transmitting video advertisements transmits a different set of video advertisements to each theater.

5. The method of claim 1, additionally comprising the step of compiling a log of the video advertisements actually displayed at each theater.

6. The method of claim 5, in which the log preparing step includes the time of display in the log.

7. The method of claim 5, additionally comprising the step of transmitting the logs to the clearing house.

8. The method of claim 7, additionally comprising the step of comparing the logs with display schedules to detect discrepancies.

9. The method of claim 1, additionally comprising the step of measuring one or more parameters representative of attendance at the theaters.

10. The method of claim 1, additionally comprising the step of measuring one or more parameters representative of audience demographics at the theaters.

11. The method of claim 9, additionally comprising the step of transmitting the one or more parameters representative of attendance to the clearing house over the network.

12. The method of claim 10, additionally comprising the step of transmitting the one or more parameters representative of audience demographics to the clearing house over the network.

13. The method of claim 1, additionally comprising the step of changing the display schedule at said theater in the course of the projection of the film.

14. The method of claim 1, comprising projecting feature films onto the screen at a number of other theaters and substituting the transmitted video advertisements for the feature films being projected at the other theaters so the transmitted video advertisements are displayed on the screens according to the schedules.

15. The method of claim 1, in which the substituted video advertisements are generated electronically.

16. A method for displaying video advertisements at a plurality of geographically separated theaters that are playing motion pictures, the method comprising:
storing a library of video advertisements at a clearing house remote from the theaters;
connecting the clearing house to the theaters through a network;
transmitting video advertisements to one of the theaters over the network;
transmitting over the network a display schedule for the video advertisements transmitted to the one theater;
playing a motion picture at the one theater; and
substituting for the motion picture being played the transmitted video advertisements according to the transmitted display schedule.
